(19) United States
(12) Patent Application Publication
(10) Pub. No.: US 2006/0159367 A1
(43) Pub. Date: Jul. 20, 2006

(54) System and method for creating variable quality images of a slide

(75) Inventors: Jack A. Zeineh, Fullerton, CA (US); Rui-Tao Dong, Mission Viejo, CA (US)

Correspondence Address: THE LAW OFFICE OF RICHARD W. JAMES, 25 CHURCHILL ROAD, CHURCHILL, PA, 15235, US

(73) Assignee: Trestle Corporation

(21) Appl. No.: 11/334,138

(22) Filed: Jan. 18, 2006

Related U.S. Application Data
(60) Provisional application No. 60/651,129, filed on Feb. 7, 2005.
(60) Provisional application No. 60/647,856, filed on Jan. 27, 2005.
(60) Provisional application No. 60/651,038, filed on Feb. 7, 2005.
(60) Provisional application No. 60/645,409, filed on Jan. 18, 2005.
(60) Provisional application No. 60/685,159, filed on May 27, 2005.

(51) Int. Cl. G06K 9/36; G06K 9/34; G06K 9/00

(52) U.S. Cl. 382/276; 382/173; 382/128

(57) ABSTRACT

Systems and methods for creating variable quality images of a slide.

### CROSS-REFERENCE TO RELATED APPLICATIONS

This application claims priority of copending U.S. Provisional Application Nos. 60/651,129, filed Feb. 7, 2005; Ser. No. 60/647,856, filed Jan. 27, 2005; Ser. No. 60/651,038, filed Feb. 7, 2005; Ser. No. 60/645,409, filed Jan. 18, 2005; and Ser. No. 60/685,159, filed May 27, 2005.

### STATEMENT REGARDING FEDERALLY SPONSORED RESEARCH

Not applicable.

### BACKGROUND

Imaging systems are used to capture magnified images of specimens, such as, for example, tissue or blood. Those images may then be viewed and manipulated, for example, to diagnose whether the specimen is diseased. Those images may furthermore be shared with others, such as diagnosticians located in other cities or countries, by transmitting the image data across a network such as the Internet. Needs exist, however, for systems, devices and methods that efficiently capture, process, and transport those images, and that display those images in ways that are familiar to diagnosticians and that make the diagnosis process less time consuming and less expensive.

### BRIEF DESCRIPTION OF THE DRAWINGS

The accompanying drawings, wherein like reference numerals are employed to designate like components, are included to provide a further understanding of an imaging and imaging interface apparatus, system, and method, are incorporated in and constitute a part of this specification, and illustrate embodiments of an imaging and imaging interface apparatus, system, and method that together with the description serve to explain the principles of an imaging and imaging interface apparatus, system and method. In the drawings:

FIG. 1 is a flow chart of an embodiment of a process for creating and reviewing a tissue;

FIG. 2 illustrates an embodiment of an image management system;

FIG. 3 is a flow chart of an embodiment of a method that may be utilized in a computerized system for diagnosing medical specimen samples;

FIG. 4 is a flow chart of an embodiment of a method for providing a quality assurance/quality control (“QA/QC”) system;

FIG. 5 is a flow chart of an embodiment of a method for providing an educational system for diagnosing medical samples;

FIG. 6 illustrates an embodiment of a graphic user interface;

FIG. 7 illustrates an embodiment of a network in which the graphic user interface may operate;

FIG. 8 is a flow chart of an embodiment of a method for creating images of a specimen;

FIG. 9 illustrates an embodiment of an image system;

FIG. 10 illustrates an embodiment of an image indexer;

FIG. 11 illustrates an embodiment of an image network;

FIG. 12 illustrates an embodiment of a process of image feature extraction; and

FIG. 13 illustrates an embodiment of an image network.

### DETAILED DESCRIPTION

Reference will now be made to embodiments of an imaging and imaging interface apparatus, system, and method, examples of which are illustrated in the accompanying drawings. Details, features, and advantages of the imaging and imaging interface apparatus, system, and method will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

As used herein, a “digital slide” or “slide image” refers to an image of a slide. As used herein, a “slide” refers to a specimen and a microscope slide or other substrate on which the specimen is disposed or contained.

The advent of the digital slide may be thought of as a disruptive technology. The analog nature of slide review has impeded the adoption of working methodologies in microscopy that leverage the efficiencies of information and other computer technology. A typical microscope user who views slides, such as an Anatomic Pathologist, may have a text database for viewing information about the slides being reviewed and may use that same information system to either dictate or type notes regarding the outcome of their review. Any capturing of data beyond that may be quite limited. Capturing slide images from a camera and sending them into a database to note areas of interest may be cumbersome, may increase the time it takes to review a slide, and may capture only those parts of a slide deemed relevant at the time one is viewing the actual slide (limiting the hindsight capability that may be desired in a data mining application).

With availability of digital slides, a missing piece in creating a digital workplace for microscopic slide review has been provided. It has now become possible in certain circumstances for all the data and processes involved with the manipulation of that data to be processed digitally. Such vertical integration may open up new applications, new workplace organizations, and bring the same types of efficiencies, quality improvements, and scalability to the process of anatomic pathology previously limited to clinical pathology.

The process of reviewing glass slides may be a very fast process in certain instances. Operators may put a slide on a stage that may be part of or used with the microscope system. Users may move the slide by using the controls for the stage, or users may remove a stage clip, if applicable, and move the slide around with their fingers. In either case, the physical movement of the slide to any area of interest may be quite rapid, and the presentation of any image from an area of interest of the slide under the microscope objective may literally be at light speed. As such, daily users of microscopes may work efficiently with systems that facilitate fast review of slide images.

Users may benefit from reviewing images at a digital workplace that provides new capabilities, whose benefits over competing workplaces are not negated by the loss of other capabilities. A configuration of digital slide technology may include an image server, such as an image server 850 described herein, which may store a digital slide or image and may send over, by “streaming,” portions of the digital slide to a remote view station. A remote view station may be, for example, an imaging interface 200 or a digital microscopy station 901 as described herein, or another computer or computerized system able to communicate over a network. In another configuration of digital slide technology, a user at a remote site may copy the digital slide file to a local computer, then employ the file access and viewing systems of that computer to view the digital slide.

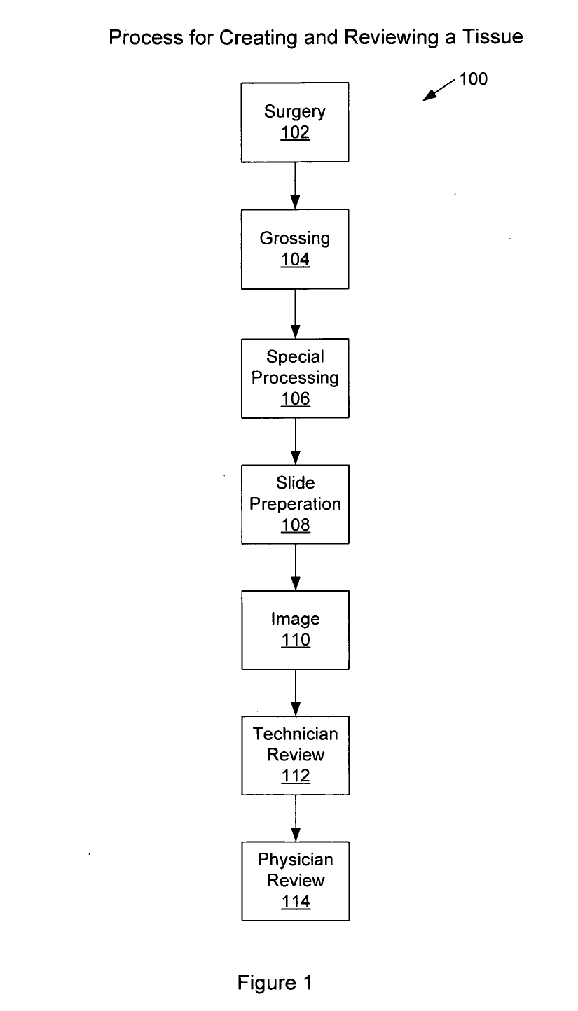

FIG. 1 is a flow chart of an embodiment of a process for creating and reviewing a tissue 100. At 102, tissue is removed or harvested from an organism, such as a human or animal by various surgical procedures, including biopsy and needle biopsy. At 104, grossing is performed, wherein the removed tissue or tissues may be viewed and otherwise contemplated in their removed form. One or more sections may then be removed from the gross tissue to be mounted on a substrate, such as a microscope slide or a microscope stage, and viewed. At 106, special processing may be performed on or in connection with the tissue. One form of special processing is the application of stain to the tissue. At 108, a slide is prepared, generally by placing the tissue on a substrate and adhering a cover slip over the tissue, or by other means. Alternately, a fluid, such as blood, or another material may be removed from the organism and placed on the substrate, or may be otherwise prepared for imaging. Tissue, fluids, and other materials and medical or other samples that are to be imaged may be referred to herein as “specimens.” For example, in various embodiments, a specimen may include a tissue sample or a blood sample.

At 110, the slide may be imaged. A slide may be imaged by capturing a digital image of at least the portion of the slide on which a specimen is located as described in U.S. patent application Ser. No. 09/919,452 or as otherwise known in the imaging technologies. A digital slide or image of a slide may be a digitized representation of a slide (and thus a specimen) sufficient to accomplish a predefined functional goal. This representation may be as simple as a snapshot or as complex as a multi-spectral, multi-section, multi-resolution data set. The digital slides may then be reviewed by a technician to assure that the specimens are amenable to diagnosis at 112. At 114, a diagnostician may consider the digital images or slides to diagnose disease or other issues relating to the specimen.

In one embodiment, a system and method is employed, at 110, for obtaining image data of a specimen for use in creating one or more virtual microscope slides. The system and method may be employed to obtain images of variable resolution of one or more microscope slides.

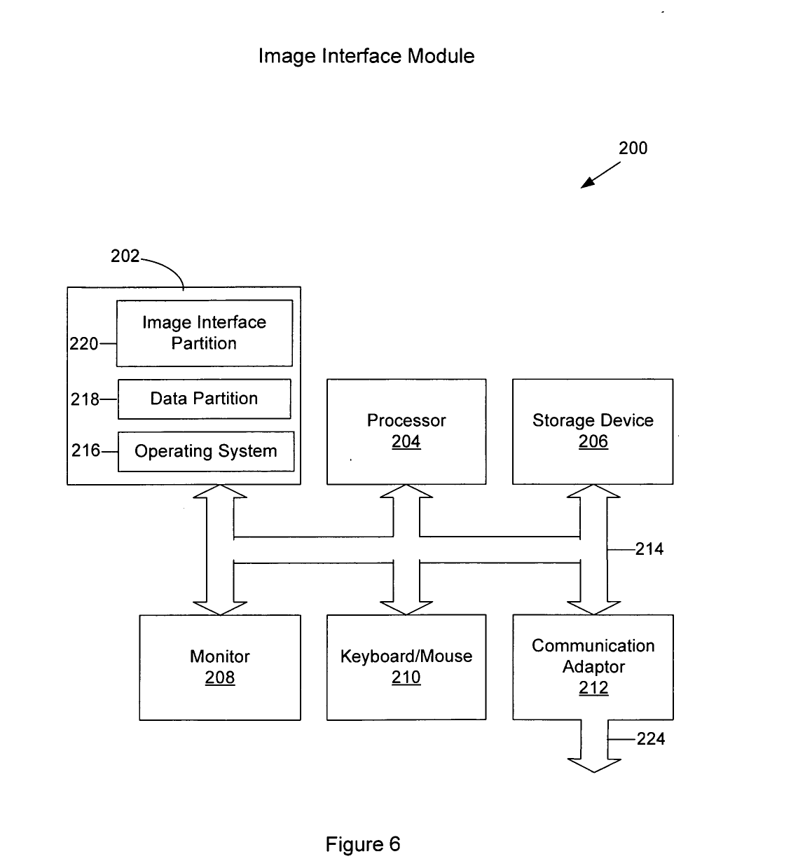

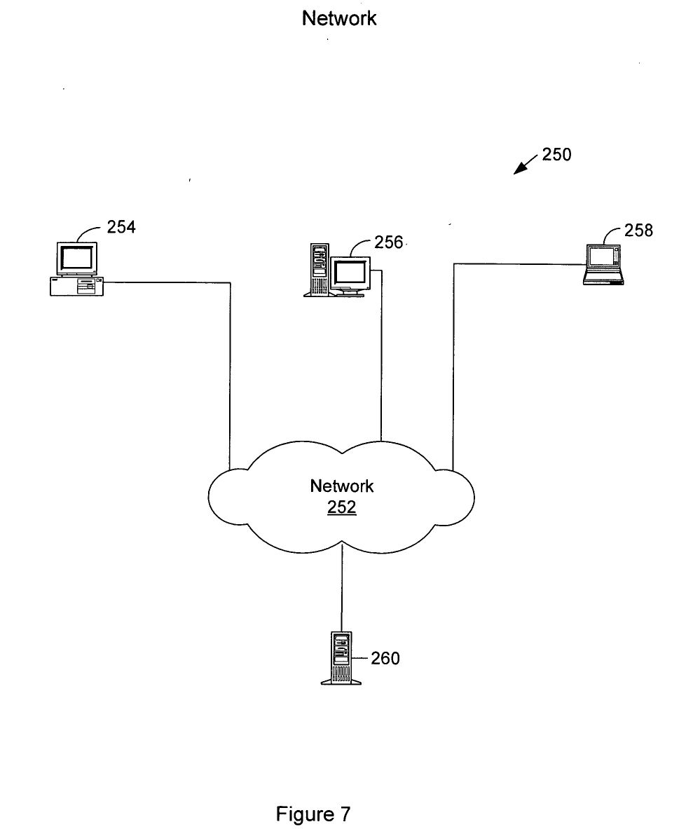

A virtual microscope slide or virtual slide may include digital data representing an image or magnified image of a microscope slide, and may be a digital slide or image of a slide. Where the virtual slide is in digital form, it may be stored on a medium, such as in a computer memory or storage device, and may be transmitted over a communication network, such as the Internet, an intranet, a network described with respect to FIG. 6 and FIG. 7, etc., to a viewer at a remote location, such as one of nodes 254, 256, 258, or 260 described with respect to FIG. 7 and which may be, for example, an image interface 200 or digital microscopy station 901 as described herein.

Virtual slides may offer advantages over traditional microscope slides in certain instances. In some cases, a virtual slide may enable a physician to render a diagnosis more quickly, conveniently, and economically than is possible using a traditional microscope slide. For example, a virtual slide may be made available to a remote user, such as over a communication network to a specialist in a remote location, enabling the physician to consult with the specialist and provide a diagnosis without delay. Alternatively, the virtual slide may be stored in digital form indefinitely for later viewing at the convenience of the physician or specialist.

A virtual slide may be generated by positioning a microscope slide (which may contain a specimen for which a magnified image is desired) under a microscope objective, capturing one or more images covering all or a portion of the slide, and then combining the images to create a single, integrated, digital image of the slide. It may be desirable to partition a slide into multiple regions or portions and to generate a separate image for each region or portion, since the entire slide may be larger than the field of view of a magnifying (20×, for example) objective lens of an imager. Additionally, the surfaces of many tissues may be uneven and contain local variations that create difficulty in capturing an in-focus image of an entire slide using a fixed z-position. As used herein, the term “z-position” refers to the coordinate value of the z-axis of a Cartesian coordinate system. The z-axis may refer to an axis in which the objective lens is directed toward the stage. The z-axis may be at a 90° angle from each of the x and y axes, or another angle if desired. The x and y axes may lie in the plane in which the microscope stage resides. Accordingly, some techniques may include obtaining multiple images representing various regions or portions of a slide, and combining the images into an integrated image of the entire slide.

One technique for capturing digital images of a microscopic slide is the start/stop acquisition method. According to this technique, multiple target points on a slide may be designated for examination. An objective lens (20×, for example) may be positioned over the slide. At each target point, the z-position may be varied and images may be captured from multiple z-positions. The images may then be examined to determine a desired-focus position. If one of the images obtained during the focusing operation is determined to be sufficiently in-focus, that image may be selected as the desired-focus image for the respective target point on the slide. If none of the images is in-focus, the images may be analyzed to determine a desired-focus position. The objective may be moved to the desired-focus position, and a new image may be captured. In some cases, a first sequence of images may not provide sufficient information to determine a desired-focus position. In such a case, a second sequence of images within a narrowed range of z-positions may be captured to facilitate determination of the desired-focus position. The multiple desired-focus images (one for each target point) obtained in this manner may be combined to create a virtual slide.

Another approach used to generate in-focus images for developing a virtual slide includes examining the microscope slide to generate a focal map, which may be an estimated focus surface created by focusing an objective lens on a limited number of points on the slide. Then, a scanning operation may be performed based on the focal map. Some techniques or systems may construct focal maps by determining desired-focus information for a limited number of points on a slide. For example, such techniques or systems may select from 3 to 20 target points on a slide and use an objective lens to perform a focus operation at each target point to determine a desired-focus position. The information obtained for those target points may then be used to estimate desired-focus information for any unexamined points on the slide.

Start/stop acquisition systems, as described above, may be relatively slow because the microscope objective may often be required to perform multiple focus-capture operations for each designated target point on the microscopic slide. In addition, the field-of-view of an objective lens may be limited. The number of points for which desired-focus information is directly obtained may be a relatively small portion of the entire slide. Techniques for constructing focal maps may also lack some advantages of other techniques in certain cases. First, the use of a high-power objective to obtain desired-focus data for a given target point may be relatively slow. Second, generating a focal map from a limited number of points on the slide may create inaccuracies in the resulting focal map. For example, tissue on a slide may often not have a uniform, smooth surface. Also, many tissue surfaces may contain variations that vary across small distances. If a point on the surface of the tissue that has a defect or a significant local variation is selected as a target point for obtaining focus information, the deviation may affect estimated values for desired-focus positions throughout the entire focal map.

Regardless of focus technique, users may continue to demand higher and higher speeds while desiring increased quality. Numerous systems may attempt to meet user demand by utilizing a region of interest detection routine as part of the image acquisition procedure. Rather than scan or otherwise image the entire slide, these systems may attempt to determine what portions of the slide contain a specimen or target tissue. Then only the area of the slide containing the specimen or target tissue may be scanned or otherwise imaged. Since most of the slide may not contain a specimen, this imaging technique may result in a significant reduction in overall scan time. While conceptually simple, in practice this technique may be hampered by many artifacts that exist in slides. These artifacts may include dirt, scratches, slide bubbles, slide coverslip edges, and stray tissue fragments. Since there may be tremendous variability with these artifacts in certain cases, such region of interest detection routines may be required to include one or more sophisticated image scene interpretation algorithms. Given a requirement that all tissue may have to be scanned or otherwise imaged, creating such an algorithm may be very challenging and may be, in some cases, unlikely to succeed 100% in practice without significant per user customization. Another option may be to make the sensitivity of the system very high, but the specificity low. This option may result in a greater likelihood the tissue will be detected because of the sensitivity, but also in the detection of artifacts because of the low specificity. That option may also effectively reduce scan or other imaging throughput and correspondingly benefit the region of interest detection.

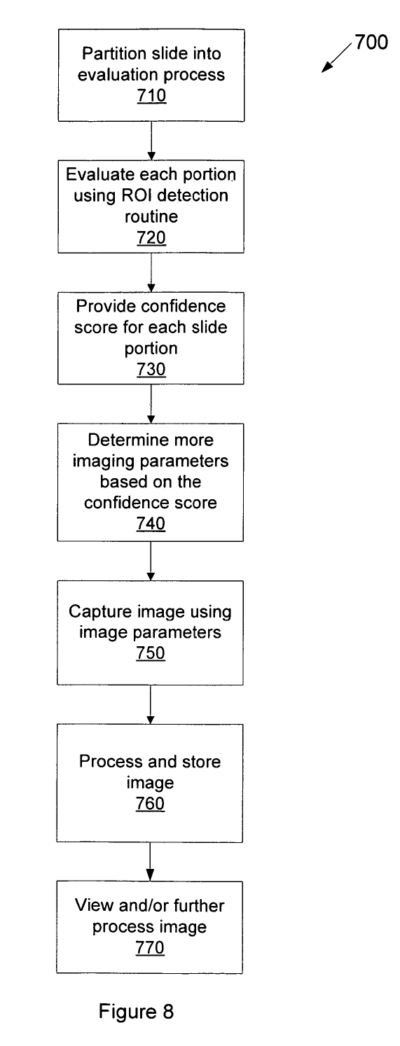

In one embodiment, the capturing of an image, at 110 of FIG. 1, employs an image creation method 700 as in FIG. 8. The image creation method 700 may incorporate one or more components. First may be a routine, which may be, for example, a set of instructions, such as in a software or other program, that may be executed by a computer processor to perform a function. The routine may be a multitiered region of interest (ROI) detection routine. An ROI detection routine may include a system or method for locating ROIs on a slide, such as regions including tissue, for imaging, such as described, for example, in U.S. patent application Ser. Nos. 09/919,452 or 09/758,037. The ROI detection routine may locate the ROls by analyzing a captured image of the slide, such as a macro image of the entire slide or an image of a slide portion. Rather than provide a binary determination as to where tissue is and is not located on a slide, the image creation method 700 may, with an ROI detection routine that is a multitiered ROI detection routine, evaluate portions of the slide by grading the captured images of the various portions, such as with a confidence score, according to their probability of including an ROI.

A multitiered ROI routine may, for example, perform such grading by thresholding certain statistical quantities, such as mean and standard deviation of pixel intensity or other texture filter output of a slide image portion to determine whether the corresponding slide portion contains tissue or nontissue. A first threshold that may be expected to include tissue may be applied to one of the first metrics, such as mean. For each pixel in the image, a mean of the surrounding pixels in, for example, a 1 mm×1 mm area, may be computed. If the mean for a given area is in the threshold range of 50-200 (in the case of an 8 bit (0-255) grey scale value), for example, then the portion of the slide to which that pixel corresponds, and thus the pixel, may be considered to include tissue. If the mean is less than 50 or greater than 200 then it may be considered not to show or otherwise include tissue. A second thresholding step may be configured to be applied to the standard deviation. Similar to the computation for mean, each pixel may have a standard deviation for it and its surrounding pixels (e.g. 1 mm×1 mm area) computed. If the standard deviation is greater than a certain threshold, say 5, then that pixel may be considered to show tissue. If it is less than or equal to the threshold then it may not be considered to show tissue. For each pixel position, the results of the first and second thresholding steps may be compared. If for a given pixel position, neither of the threshold operations indicate that the pixel shows tissue, then the pixel may be assigned as non-tissue. If only one of the thresholds indicates that the pixel shows tissue, the pixel may be given a medium probability of showing tissue. If both indicate that the pixel shows tissue, then both may be considered to show tissue.

Alternatively, in one embodiment, the single threshold can be maintained and an enhancement applied at the tiling matrix phase, or phase in which the slide image is partitioned into tiles or pixels or other portions. The number of pixels marked as showing tissue as a percentage of total pixels in the tiling matrix may be used as a confidence score. A tile with a large amount of positive pixels, or pixels marked as showing tissue, may be highly likely to show tissue, whereas a tile with a very low amount of positive pixels may be unlikely to actually show tissue. Such a methodology may result in a more continuous array of scores (e.g., from 0 to 100), and may thus allow for a more continuous array of quality designations for which each pixel or other portion is to have an image created.

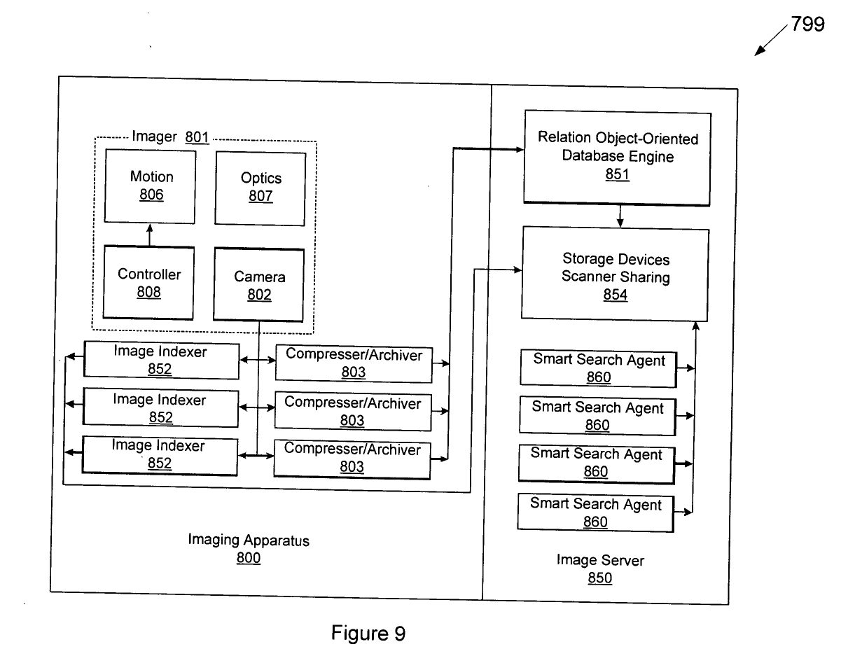

The image creation method 700 may, at 710, identify one or more slide portions to be evaluated. Thus, the image creation method 700 may, at 710, initially segment the slide image into evaluation portions, such as by partitioning the slide image, in an embodiment, into a uniform grid. An example would be partitioning a 50 mm×25 mm area of a slide into a 50 by 25 grid that has 1250 portions that are blocks, each defining an approximately 1 mm² block. In one embodiment, the image creation method 700 at 710 includes first capturing an image of at least the slide portions to be identified for evaluation, such as with the imager 801 of FIG. 9 or otherwise as described herein, for example.

Each block may, at 720, be evaluated. Each block in the example may, at 730, be given a confidence score that corresponds to the probability of the area of that block containing tissue. The confidence score, or ROI probability or likelihood, may determine or correspond with, or otherwise influence, the quality, as determined at 740 and discussed below, with which an image of the block or other portion is to be acquired, at 750, by the imaging apparatus, such as the imaging apparatus 800 embodiment of FIG. 9. Quality of an image may be dependent upon one or more imaging parameters, such as resolution, stage speed, scan or other imaging settings, bit or color depth, image correction processes, and/or image stitching processes. In one embodiment, the multitiered ROI detection routine may include 720, 730, and possibly also 740 In another embodiment, the multitiered ROI detection routine may also include the partitioning of the slide, at 710, into evaluation portions.

In one embodiment, resolution of the slide image or specimen image is the most directly relevant metric of image quality. The resolution of an image created by an imager, such as the imager 801 of FIG. 9 as described herein, may refer to the sharpness and clarity of the image, and may be a function of one or more of the criteria of the imager, including digital resolution, resolving power of the optics, and other factors. Digital resolution refers to the maximum number of dots per area of a captured digital image. Portions of an image with the highest probabilities of having tissue may, at 750, be scanned or otherwise imaged at the highest resolution available, which may correspond to the highest quality in some circumstances. Portions with the lowest probability of having tissue and thus the lowest confidence scores may, at 750, be imaged at the lowest quality, which may correspond to the lowest image resolution available. The confidence score may be directly correlated to imaging resolution, and/or one or more other forms of image quality or other desired imaging parameters, such as described herein.

In an embodiment where an image of the portion or portions having the lowest quality has already been captured, such as at 710 for purposes of evaluation by the multitiered ROI detection routine, the already captured image may be used, and the portion or portions may not be reimaged, such as described with respect to image redundancy below.

Depending on the capabilities of an image system according to one embodiment, one or more intermediate resolutions that correspond to intermediate probabilities of tissue, and thus to intermediate confidence scores, may be determined at 740 and imaged at 750. If the imager or imaging apparatus has discrete resolutions, the number of intermediate resolutions may fundamentally be discrete. For example, with 5 objective magnifications available (2×, 4×, 10×, 20×, 40×), the system may define the lowest resolution imaging as being done with a 2× objective, the highest resolution with a 40× objective, and three intermediate resolutions with 4×, 10×, and 20× objectives.

In an embodiment with discrete resolution choices, the probability of a slide portion containing tissue, and thus the confidence score determined at 730, may be binned into one of the resolutions for purposes of defining, at 740, an imaging resolution setting for that portion. For example, the image creation method 700 may include binning the slide portion, such as at 740, by storing its location on the slide along with the resolution in which that slide portion is to be imaged.

The determination of the bin may be done, at 740, by any of various methods including, for example, thresholding and adaptive thresholding. In an example of simple thresholding in the case of three discrete resolution options, two thresholds may be defined. The first threshold may be a 10% confidence score and the second threshold may be a 20% confidence score. That is, confidence scores less than 10% may be categorized in the lowest resolution bin. Confidence scores less than 20% but greater than or equal to 10% may be in the medium resolution bin. Confidence scores greater than or equal to 20% may be in the highest resolution bin.

In an example of adaptive thresholding, the highest and lowest probability scores, and thus the highest and lowest confidence scores for the grid portions of a particular specimen, may be computed. A predefined percentage of the difference between the highest and lowest confidence scores may be added to the lowest confidence score to determine a low resolution threshold confidence score. Confidence scores for portions falling between the low confidence score and the low threshold may be categorized in the lowest resolution bin. A different (higher) percentage difference between the highest and lowest confidence scores may be added to the lowest confidence score to determine the next, higher resolution threshold and so on for all the different resolutions. The various percentage difference choices may be determined as a function of various parameters, which may include, for example, the number of objectives available to the system, their respective image resolving powers, and/or the best available resolution at the top of the range.

In one embodiment, an example of the image creation method 700 may include, at 720, 730, and 740, analyzing a slide or other sample and determining that it has, among its evaluation portions, a lowest confidence score of 5 and a highest confidence score of 80. These scores may correspond to probability percentages regarding whether the portions are ROls, or may correspond to other values. The image creation method 700 may be employed with an imager, such as the imager 801 as described herein, that may have three discrete resolution options—2 microns per pixel resolution, 0.5 micron per pixel resolution, and 0.25 micron per pixel resolution, for example. A first threshold may be defined as the lowest value plus 10% between the difference of the highest and lowest values, or 5+((80−5)*0.1)=12.5. A second threshold may be defined as the lowest value plus 20% between the difference of the highest and lowest values 5+((80−5)*0.2)=20. Portions with confidence scores less than the first threshold may be imaged at 2 microns per pixel. Portions and with confidence scores equal to or above the first threshold but less than the second threshold may be imaged at 0.5 microns per pixel. Regions with confidences scores equal to or above the second threshold may be imaged at 0.25 microns per pixel.

In another embodiment, discrete resolution choices may, at 740, be turned into a more continuous set of quality choices by adding other image acquisition parameters that affect image quality to the resolution algorithm. In the case of a continuous scanning or other imaging apparatus, stage speed may be one of the image acquisition parameters that may have a significant effect on image quality. Higher stage speeds may often provide higher image capture technique speeds, but with corresponding lower image resolution, and thus quality. These properties associated with imaging at higher stage speeds may be employed in combination with multiple objectives. A nominal image resolution may be associated with a nominal imaging speed which, for example, may be in the middle of the speed range. Each objective may be associated with multiple imaging speed settings, both faster and slower than the nominal imaging speed, such that changes in imaging speed changes from the nominal imaging speed for that objective lens may be used to increase or decrease the resolution of an image captured with that objective. This technique of varying stage speed during imaging may allow the number of quality bins to be expanded beyond the number of objectives, such as by including bins associated with each objective and additional or sub-bins for two or more stage speeds associated with one or more of those objectives.

For example, there may be two main bins designated for portions to be imaged with 10× and 20× scanning objectives, respectively. These two main bins may be subdivided into two smaller bins: 10× objective, stage speed 50 mm/sec; 10× objective, stage speed 100 mm/sec; 20× objective, stage speed 25 mm/sec; and 20× objective, stage speed 50 mm/sec.

In another embodiment, a multiplane acquisition method, the number of focal planes in which images are to be captured, at 750, may be a variable that affects quality and speed of image capture. Therefore, the number of focal planes, or focal distances, may also be used to provide, at 740, additional quality bins. In the case of systems that employ multiple focal planes to improve focus quality through plane combination (e.g., the imaging of a slide at various z-positions), more planes may correspond to a higher probability of the highest possible resolution being available for the objective for imaging. As a consequence, the number of focal planes captured may be used to provide, at 740, more resolution bins or quality bins for an objective. The lowest quality bin for an objective may have one focal plane, whereas the highest quality bin may have 7 focal planes, for example. Each objective may have its own unique bin definitions. For example, a 2× objective may have only one bin with one focal plane whereas a 10× objective may have three bins—the lowest quality with one focal plane, another quality with two focal planes, and the highest quality with three focal planes. The number of quality bins appropriate for a given imaging objective may be user definable, but may be proportional to the numerical aperture (NA) of the objective, with higher NA objectives having more focal planes. For example, a high NA objective of 0.95 may have 10 focal planes whereas a lower NA objective of 0.5 may have 3 focal planes.

The resulting imaging data may produce image data for the entire desired area of the slide. However, each portion of the acquired image area may have been captured, at 750, at different quality settings. The system may inherently provide for the ability to eliminate redundancies in imaged areas. For example, the system may, by default, not image, at 750, the same area with more than one quality setting, which may increase the efficiency of the system. For example, if data to be used to capture an image, such as a tiling matrix having portions that are tiles (e.g. square or other shaped portions), indicates that a portion of an image is to be acquired at more than one quality level, then that portion may be imaged at the highest quality level indicated.

Image quality may be dependent on various imaging parameters, including, for example, the optical resolution of the objective lens and other aspects of the optics, the digital resolution of the camera or device capturing the image and other aspects of the image capturing device such as bit-depth capturing ability and image compression level and format (e.g. lossless, lossy), the motion of the specimen in relation to the optics and image capturing device, strobe light speed if applicable, the accuracy with which the optics and image capturing device are focused on the specimen being imaged, and the number of possible settings for any of these imaging parameters.

Focus quality, and thus image quality, may furthermore be dependent on various focus parameters, including, for example, number of focal planes, and focus controls such as those described in U.S. patent application Ser. No. 09/919,452.

Other parameters that may affect image quality include, for example, applied image correction techniques, image stitching techniques, and whether the numerical aperture of the optics is dynamically-adjustable during imaging.

Alternative configurations and embodiments of an image creation method 700 may provide for imaging redundancy. Image redundancy may be a useful mechanism to determine focus quality of an imaged area. For example, a lower quality but higher depth of field objective, such as a 4× objective, may be employed to image a given area. A higher quality but narrower depth of field, such as a 20× objective, may be employed to image that same area. One may determine the focus quality of the 20× image by comparing the contrast range in the pixel intensities in the 20× image with that of the 4× image. If the 20× image has lower contrast than the 4× image, it may be that the 20× image is out of focus. The technique may be further refined by analyzing the corresponding images obtained from the 4× and 20× objectives in a Fourier space along with the respective OTF (Optical Transfer Function) for the objectives. The Fourier transform of the 4× image is the product of the OTF of the 4× objective and the Fourier transform of the target. The same may hold for the 20× objective. When both images are in focus, the target may be identical. Therefore, the product of the 4× OFT and the 20× Fourier image may equal the product of the 20× OFT and the 4× Fourier image. As the 4× image may be mostly likely to be in focus, large deviations from the above equation may mean that the 20× image is out of focus. By taking absolute values on both sides of the equation, the MTF (Modulation Transfer Function) may be used instead of the OTF, as it may be more readily available and easier to measure.

The OTF and MTF may either be obtained from lens manufacturers or measured by independent labs. In practice, an estimated OTF or MFT may be used for the type of the objective, rather than obtaining OTF/MTF for each individual objective.

Other practical considerations may including minimizing the contribution of system noise by limiting the range of frequencies in the comparison. Configuration may be needed to determine the most effective range of frequencies for the comparison and what constitutes a large deviation in the equation. Configuration may also be need for different target thickness. In an embodiment, image redundancy may be achieved through multiple binning steps. A given grid block or other portion of a slide may be put into a second bin by application of a second binning step with one or more rules. For example, in addition to the binning that may be part of 740 as described above, a second rule may be applied at 740. An example of a second rule is a rule that puts all blocks or other portions of the specimen in the lowest resolution or quality bin in addition to the bin that they were put into during the first binning step. If the first binning step resulted in that block or other portion being put into the lowest resolution or quality bin, then no additional step may occur with respect to that block or other portion, since that block or other portion was already in that bin.

If an original image that was utilized to determine the ROls is of adequate quality, it may be utilized as a data source. The original image may serve as a redundant image source or it may be utilized to provide image data to one of the bins. For example, if the image for determining ROls was made using a 2× objective, this image may be utilized to provide image data for the 2× bin. This may afford efficiency, since data already captured could be used as one of the redundant images.

In one embodiment, the determination of the area to be imaged may be specified by the user before imaging. Additional parameters such as, for example, imager objective, stage speed, and/or other quality factors may also be user adjustable. Focus point or area selection may be manual or automated. In the case of manual focus point or area selection, the user may mark areas on a slide to capture focus points or areas from which to create a focus map. In the case of an automated system for focus point or area detection, an automated ROI detection routine is applied but it serves to provide focus points for a focus map rather than define the imaging area. The focus map may be created as described in pending U.S. patent application Ser. No. 09/919,452, for example.

FIG. 9 illustrates an image system 799, in accordance with an embodiment. Images that are acquired may be compressed such as shown in and described with respect to the compressor/archiver 803 of the image system 799 of FIG. 9, and stored on a permanent medium, such as a hard disk drive and/or a storage device 854 of an image server 850, such as described herein with respect to FIG. 9. Many formats may be employed for compressing and storing images. Examples of such formats include JPEG in TIFF, JPEG2000, GeoTIFF, and JPEG2000 in TIFF. Any given area may have a corresponding set of imaged data, which may be stored in a file. If there is more than one image available for a given imaging area, both may be stored. Multi area storage may be accomplished by a process that includes creating multiple image directories in each file, with each directory representing one image.

Returning to FIG. 8, when an image is going to be used, at 760, by, for example, a human for viewing purposes at a view station such as an image interface 200 or digital microscopy station 901 described herein, or for computer based analytical purposes, one or more additional rules may be employed for extracting and rendering image data. An image request, at 760, may comprise a request for an image of an area of a slide to be displayed as well as a zoom percentage or resolution associated therewith. If image data at the requested zoom percentage or resolution level for the area requested does not exist for all or a portion of the requested image data, then the system, according to one embodiment, may employ sampling techniques that serve to resample (upsample or downsample) the necessary portion of the image to the requested zoom specification.

For example, if the user requested an image, at 760, for a given area defined by rectangle ‘A’ with a zoom percentage of 100%, but the system had data available for only one half the image at 100% zoom and the other half only at 50%, the system may upsample the 50% image to create an image equivalent in zoom percentage to 100%. The upsampled data may be combined with the true 100% image data to create an image for the area defined by rectangle A at 100%. This upsampling may occur before transmission or after transmission to a client such as nodes 254, 256 , and 258 in FIG. 7, from a server 260. Upsampling after transmission may provide efficiency in minimizing size of data transmitted. As an embodiment of this invention may create images at multiple qualities, some regions may be likely to have all desired data at the requested quality, while other regions may have only part of the area available at the requested quality and may therefore have to resample at 750 using altered imaging parameters. Other regions may not have any of the requested qualities available and may have to resample for the entire area.

Triggered z capture may include, for example, capturing, such as at 710 or 750, one or more images of all or part of a target when the optics of the imager, such as the imager 801 embodiment of FIG. 9, are positioned at one or more desired focal lengths. The imager 801 may capture those images based on a commanded optic position or as sensed by a position sensor.

One embodiment includes a method for capturing multiple focal planes rapidly. The z axis control system on a microscope used in the system, such as the microscope optics 807 of the imager 801 as in FIG. 9, may be set in motion along a predetermined path. During this motion, an encoder or similar device to indicate z-position may send position data to a controller device. At predetermined positions, the controller may fire a trigger pulse to a camera, such as the camera 802of the imager 801, strobe light, or other device in order to effectuate capture of an image at a specified z-position. Capture of multiple images along with corresponding z-position data for each image may provide a multifocal plane data set as well as providing data to calculate a z-position of optimum or desired focus. This optimum or desired focus calculation may be performed by various methods, such as by a method employing a focal index based upon entropy.

An alternative embodiment to triggering the exposure of the camera is to run the camera in a free run mode where the camera captures images at a predetermined time interval. The z position for each image grabbed can be read from the z encoder during this process. This provides a similar z stack of images with precise z positions for each image. Utilization of such a free run mode may be advantageous because it may give access to a wider range of cameras and be electronically simpler than triggered exposure.

In an embodiment, the quality of a slide image may be dependent upon both the quality of the captured image and any post-image capture processing that may change the quality.

In an embodiment, the post processing of captured images of variable resolution may include selecting images or portions thereof based upon image quality, which may depend, at least in part, on focus quality. In an embodiment, the post processing may include weighting image portions corresponding to adjacent portions of the imaged slide. Such weighting may avoid large variations of focal planes or other focal distances in which adjacent slide portions were imaged, and may thus avoid the appearance of a separating line and/or other discontinuity in the corresponding image portions when assembled together. Such weighting may also avoid an appearance of distortion and/or other undesirable properties in the images.

For example, in an embodiment where an image is captured in square or rectangular portions, a selected portion may have eight adjacent portions when the digital image is assembled. The selected portion and the adjacent portions may furthermore be captured at ten focal lengths. If the best focal length for the selected portion is the sixth focal length and the best focal lengths for the adjacent tiles vary from the eighth to the ninth focal lengths, then the seventh focal length may be used for selected portion to limit the variance of its focal length relative to those of the adjacent portion, so as to avoid undesirable properties such as described above.

In another embodiment, slide images that were captured, at 750, at one or more resolution(s) are modified, at 760, so as to comprise a new variable quality slide image. The modification may include designating quality settings for given areas, which may each include one or more portions in one embodiment, of the slide image. While viewing a slide, the user may be able to designate numerous portions or areas of the slide image for resaving at a new quality setting. This area designation may be by freehand drawing of a closed area, or by a rectangle, a circle, or other area designation. The user may modify multiple quality properties for each area, including resolution, compression level, and number of focal planes (in the case of a multifocal plane scan). The user may also designate an area for a complete whiteout or blackout that may include completely eliminating data from that area of the slide in order to achieve a higher or the highest possible compression. Additional compression may also be achieved by referencing another white or black block or other area instead of storing the white or black block or other area.

The user may also crop the slide image in order to make the slide image smaller in size. The combination of cropping and user selected area reprocessing, such as described above, may be applied to the slide image data, and a new slide may be assembled. The new slide may have the same name as the previous slide or a different name. For file formats that support rewrite, it may be possible to modify the original slide without creating a completely new slide. Such a mechanism may be more time efficient, particularly for slide images that do not have significant areas of change.

These post processing methods may be employed in an automated QC System such as described herein, for example.

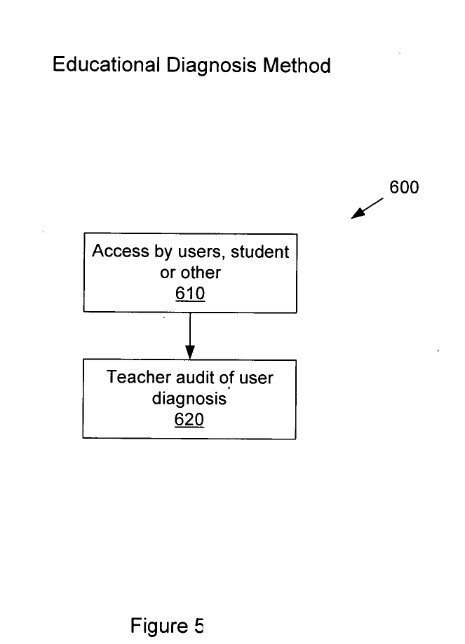

Annotations associated with images may be added at 760, such as for storing on or in association with the images on a server, such as the image server 850 described herein, and may have multiple fields associated with them, such as user and geometric descriptions of the annotation. Adding a z-position to the annotation may provide further spatial qualification of the annotation. Such qualification may be particularly useful in educational settings, such as where the education system 600 of FIG. 5 is employed, where an instructor wants to call attention to a feature lying at a particular x, y, z position.

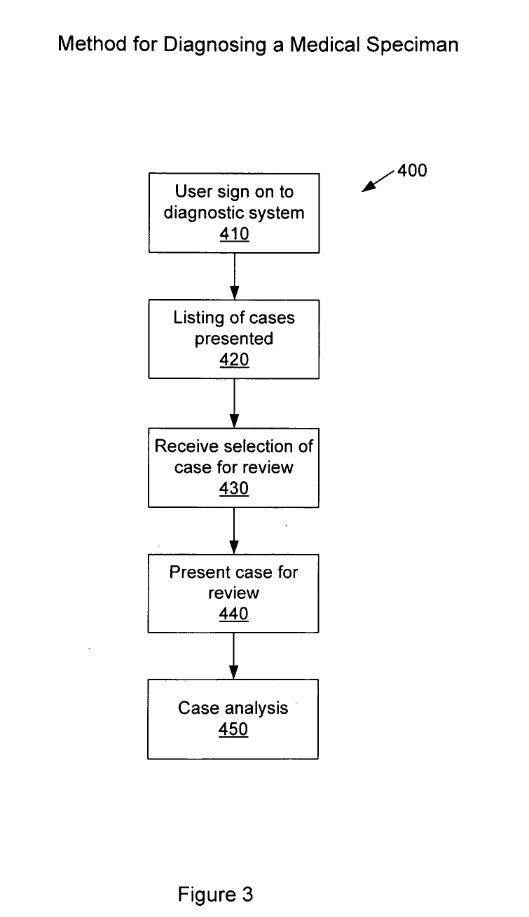

In one embodiment, the adding of annotations may be done by use of the diagnostic system 400 embodiment of FIG. 3, such as described herein.

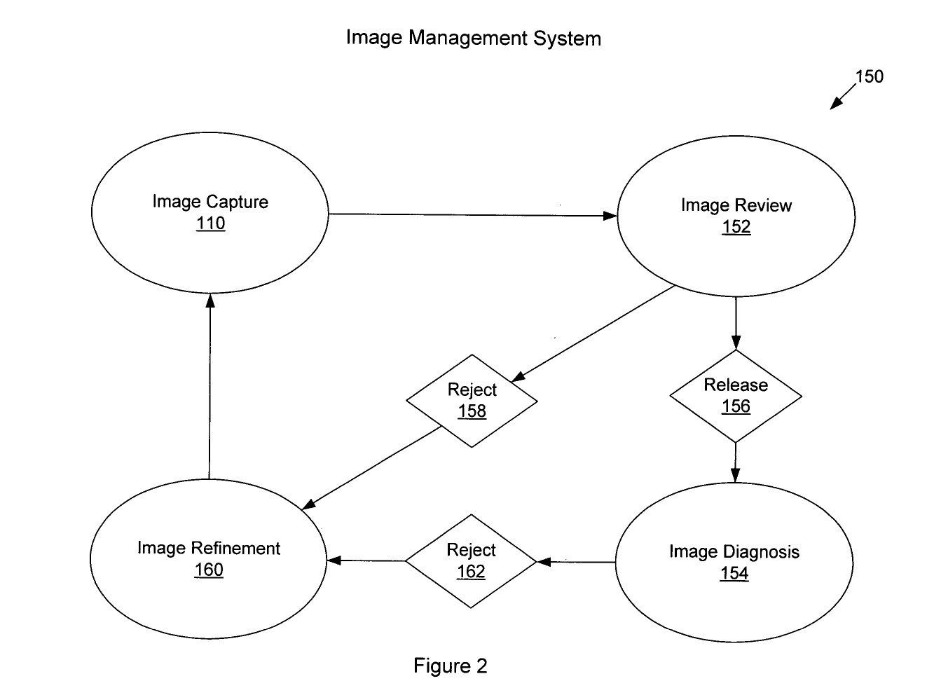

FIG. 2 illustrates an embodiment of an image management system 150 that may be utilized to permit bulk approval of images after imaging has been completed. At 110, an image of a specimen is captured. The image may be reviewed, at 152, by a specimen review system or a technician, for example, to confirm that the image is appropriate for review or amenable to diagnosis 154 by a diagnoser such as a diagnostic system, a physician, a pathologist, a toxicologist, a histologist, a technician or another diagnostician. If the image is appropriate for review, then the image may be released to the diagnostic system or diagnostician at 156. If the image is not appropriate for review, then the image may be rejected at 158. A rejected image may be reviewed by an image refiner 160 such as an image refining system or an image specialist technician. New imaging parameters may be determined for the specimen, such as by way of the image creation method 700 described with respect to the embodiment of FIG. 8, and a new image of the specimen may be captured by the image capture system 110. The diagnostic system or diagnostician may also reject images at 162 and those rejected images may be reviewed by the image refining system or image specialist technician 160 and a new image may be captured under new conditions by the image capture system 110.

Image review 152 may involve a computerized system or a person determining, for example, whether a new specimen is likely required to achieve a diagnosis or whether the existing specimen may be re-imaged to attain an image that is useful in performing a diagnosis. A new specimen may be required, for example, when the specimen has not been appropriately stained or when the stain was improperly applied or overly applied making the specimen too dark for diagnosis. One of many other reasons an image may be rejected such that a new specimen should be mounted is damage to the imaged specimen such that diagnosis may not be made from that specimen. Alternately, an image may be rejected for a reason that may be corrected by re-imaging the existing specimen.

When an image is rejected at 158, the image may be directed to the image refining system or the image specialist technician 160. Where it appears possible to improve the image by recapturing an image from the existing specimen, the image refining system or image specialist technician may consider the image and determine a likely reason the image failed to be useful in diagnosis. Various imaging parameters may be varied by the image refining system or image specialist technician to correct for a poor image taken from a useable specimen. For example, a dark image may be brightened by increasing the light level applied to the specimen during imaging and the contrast in a washed out image may be increased by reducing the lighting level applied to the specimen during imaging. A specimen or portion of a specimen that is not ideally focused may be recaptured using a different focal length, and a tissue that is not completely imaged may be recaptured by specifying the location of that tissue on a slide and then re-imaging that slide, for example. Any other parameter that may be set on an imager may similarly be adjusted by the image refining system or the image specialist technician.

Similarly, the diagnostician 154 may reject one or more images that were released at 156 by the image refining system or the image specialist technician 160 if the diagnostician 154 determines that refined images are desirable. Images may be rejected by the diagnostician 154 for reasons similar to the reasons the image refining system or the image specialist technician 160 would have rejected images. The rejected images may be directed to the image refining system or the image specialist technician 160 for image recapture where such recapture appears likely to realize an improved image.

In an embodiment, the image review 152 and image rejection 158 may include one or more parts of the image creation method 700 embodiment of FIG. 8, either alone or in conjunction with review by a person, such as a diagnoser or an image specialist technician.

Referring again to FIGS. 1 and 2, case management may be incorporated into image review 152 or elsewhere, to organize images and related text and information into cases. Case management can be applied after all desired images have been captured and related information has been collected and case management can also be applied prior to collecting images and related text by, for example, informing a user of how many and what types of images and related text are expected for a case. Case management can inform a user of the status of a case or warn a user of missing information.

When a tissue specimen is removed or harvested 102, it is often separated into numerous specimens and those specimens are often placed on more than one slide. Accordingly, in an embodiment of case management, multiple images from multiple slides may, together, make up a single case for a single patient or organism. Additionally, a Laboratory Information System (“LIS”), Laboratory Information Management System (“LIMS”), or alternative database that contains relevant case information such as, for example, a type of specimen displayed, a procedure performed to acquire the specimen, an organ from which the specimen originated, or a stain applied to the specimen, may be included in or may communicate with the image management system 150 such that information may be passed from the LIS or LIMS to the image management system and information may be passed from the image management system to the LIS or LIMS. The LIS or LIMS may include various types of information, such as results from tests performed on the specimen, text inputted at the time of grossing 104, diagnostic tools such as images discovered in the same organ harvested from other patients having the disease suspected in the case and text that indicates conditions that are common to the disease suspected in the case, which may be associated with the case as desired. Thus, during image review 152, all images and related information for each case may be related to that case in a database. Such case organization may assist in image diagnosis by associating all information desired by diagnostic system or diagnostician so that the diagnostic system or diagnostician can access that information efficiently.

In one embodiment of a case management method, which may be implemented in a computerized system, a bar code, RFID, Infoglyph, one or more characters, or another computer readable identifier is placed on each slide, identifying the case to which the slide belongs. Those areas on the slide with the identifier, typically called the ‘label area,’ may then be imaged with the slides or otherwise read and associated with the slides imaged to identify the case to which the slide belongs. Alternately, a technician or other human may identify each slide with a case.

In an embodiment, imaging parameters may be set manually at the time the image is to be captured, or the parameters may be set and associated with a particular slide and retrieved from a database when the image is to be captured. For example, imaging parameters may be associated with a slide by a position in which the slide is stored or placed in a tray of slides. Alternately, the imaging parameters may be associated with a particular slide by way of the bar code or other computer readable identifier placed on the slide. The imaging parameters may be determined, in an embodiment, at least in part by way of the image creation method 700 of FIG. 8 as described herein.

In one embodiment, an imager checks for special parameter settings associated with an image to be captured, utilizes any such special parameter settings and utilizes default parameters where no special parameters are associated with the image to be captured. Examples of such imaging parameters include resolution, number of focal planes, compression method, file format, and color model, for example. Additional information may be retrieved from the LIS, LIMS, or one or more other information systems. This additional information may include, for example, type of stain, coverslip, and/or fixation methods. This additional information may be utilized by the image system to derive imaging parameters such as, for example, number of focus settings (e.g., number of points on which to focus, type of curve to fit to points, number of planes to capture), region of interest detection parameters (e.g., threshold, preprocessing methods), spectral imaging settings, resolution, compression method, and file format. These imaging parameters may be derived from the internal memory of the scanner itself or another information database. Then, as the slides are picked and placed on the imaging apparatus, the appropriate imaging parameters may be recalled and applied to the image being captured.

Information retrieved about the slide from the LIS, LIMS or other information system may also be utilized by an automated Quality Control (“QC”) system that operates during or after slide imaging. The automated QC system may check to see that the stain specified in the LIS or LIMS is the actual stain on the slide. For example, the LIS may specify that the stain for that slide should be H+E, analysis may reveal that the stain is Trichrome. Additionally, the LIS may specify the type of tissue and/or the number of tissues that should be on the slide. A tissue segmentation and object identification algorithm may be utilized to determine the number of tissues on the slide, while texture analysis or statistical pattern recognition may be utilized to determine type of tissue.

The automated QC system may also search for technical defects in the slide such as weak staining, folds, tears, or drag through as well as imaging related defects such as poor focus, seaming defects, intrafield focus variation, or color defects. Information about type and location of detected defects may be saved such that the technician can quickly view the suspected defects as part of the slide review process done by the technician or image specialist technician. A defect value may then be applied to each defect discovered. That defect value may reflect the degree the defect is expected to impact the image, the expected impact the defect will have on the ability to create a diagnosis from the image, or another quantification of the effect of the defect. The system may automatically sort the imaged slides by order of total defects. Total defects may be represented by a score that corresponds to all the defects in the slide. This score may be the sum of values applied to each defect, the normalized sum of each defect value, or the square root of the sum of squares for each value. While a defect score may be presented, the user may also view values for individual defects for each slide and sort the order of displayed slides based upon any one of the individual defects as well as the total defect value. For example, the user may select the focus as the defect of interest and sort slides in order of the highest focus defects to the lowest. The user may also apply filters such that slides containing a range of defect values are specially pointed out to the user.

The automated QC system may also invoke an automated rescan process. The user may specify that a range of defect values requires automatic rescanning (note that this range of defect values may be a different range than that used for sorting the display previously mentioned.) A slide with a focus quality of less than 95% of optimal, for example, may automatically be reimaged.

The slide may be reimaged with different scan or other imaging settings. The different imaging settings may be predetermined or may be dynamically determined depending on the nature of the defect. An example of reimaging with a predetermined imaging setting change is to reimage the slide with multiple focal planes regardless of the nature of the defect. Examples of reimaging with a dynamically determined imaging setting are to reimage using multiple focal planes if focus was poor, and to reimage with a wider search area for image alignment in the case of seaming defects.

Alternately or in addition, where the diagnoser determines that a diagnosis is not possible from the image, a slide may be loaded into a microscope and reviewed directly by the diagnoser. Where the diagnoser is at a location remote from the slide and microscope, the diagnoser may employ a remote microscope control system to perform a diagnosis from the slide.

FIG. 3 is a flow chart of an embodiment of a method that may be utilized in a computerized system for diagnosing medical samples or other specimens 400, such as human or animal tissue or blood samples. The diagnostic system 400 may include, and the method may employ, a computerized database system, wherein information in the database is accessible and viewable by way of an imaging interface computer application with a user interface, such as a graphical user interface (“GUI”). In an embodiment, the computer application may operate over a network and/or the Internet. In one embodiment, once one or a group of images of specimens has been accepted for review, a user such as a histologist or other researcher may access images of the specimens through the diagnostic system 400. In one embodiment a user, at 410, signs on or otherwise accesses the diagnostic system 400. The diagnostic system 400 may require that a user provide a user identification and/or a password to sign on.

Once the user has signed on, the system may, at 420, present a listing of cases to which the user is contributing and/or with which the user is associated. Additionally, the user may be able at 420 to access cases to which he or she has not contributed and/or is not associated. The diagnostic system 400 may facilitate finding such other cases by employing a search bar and/or an index in which cases are categorized by name, area of medicine, disease, type of specimen and/or other criteria. The diagnostic system 400 may include at 420 a function whereby a system, by user prompt, will retrieve cases with similarities to a case assigned to the user. Similarities may be categorized by area of medicine, disease, type of specimen, and/or other criteria.

At 430, the user may select a case for review, such as by mouse-clicking a hyperlink or inputting the name of the case via an input device such as a computer keyboard. When a case has been selected, the diagnostic system 400 may, at 440, present the case for analysis by way of the imaging interface.

At 450, the user may analyze the case. The user at 450 may analyze the case by viewing information components of the case by way of the imaging interface in window form. In window form, specimen images and other case information may be viewed in windows that may be resized by the user dependent upon the information and/or images the user wishes to view. For example, at 450 the user may prompt the imaging interface to present, on the right half of the viewing screen, one or more images of tissue samples disposed on slides, and on the left half, text describing the medical history of the patient from which the specimen was removed. In one embodiment, the diagnostic system 400 may allow a user to view, at 450, multiple views at once of a tissue sample, or multiple tissue samples.

In one embodiment, the imaging interface may include a navigation bar that includes links to functions, such as Tasks, Resources, Tools, and Support, allowing the user to quickly access a function, such as by mouse-click. The specific functions may be customizable based upon the type of user, such as whether the user is a pathologist, toxicologist, histologist, technician, or administrator. The imaging interface may also include an action bar, which may include virtual buttons that may be “clicked” on by mouse. The action bar may include functions available to the user for the screen presently shown in the imaging interface. These functions may include the showing of a numbered grid over a specimen image, the showing of the next or previous of a series of specimens, and the logging off of the diagnostic system 400. The diagnostic system 400 may allow a user to toggle the numbered grid on and off.

In one embodiment, the diagnostic system 400 allows a user, such as via the navigation or action bar, to view an image of a specimen at multiple magnifications and/or resolutions. For example, with respect to a specimen that is a tissue sample, a user may prompt the diagnostic system 400 to display, by way of the imaging interface, a low magnification view of the sample. This view may allow a user to see the whole tissue sample. The diagnostic system 400 may allow the user to select an area within the whole tissue sample. Where the user has prompted the diagnostic system 400 to show a numbered grid overlaying the tissue sample, the user may select the area by providing grid coordinates, such as grid row and column numbers. The user may prompt the diagnostic system 400 to “zoom” or magnify that tissue area for critical analysis, and may center the area within the imaging interface. Where the user has prompted the system to show a numbered grid overlaying the tissue sample, the user may select the area by providing grid coordinates.

In one embodiment, the diagnostic system 400 allows a user, such as via navigation or action bar, to bookmark, notate, compare, and/or provide a report with respect to the case or cases being viewed. Thus, the user may bookmark a view of a specific area of a tissue sample or other specimen image at a specific magnification, so that the user may access that view at a later time by accessing the bookmark.

The diagnostic system 400 may also allow a user to provide notation on that view or another view, such as a description of the tissue sample or other specimen view that may be relevant to a diagnosis.

The diagnostic system 400 may also allow a user to compare one specimen to another. The other specimen may or may not be related to the present case, since the diagnostic system 400 may allow a user to simultaneously show images of specimens from different cases.

The diagnostic system 400 may also allow a user to provide a report relevant to the specimens being viewed. The report may be a diagnosis, and may be inputted directly into the diagnostic system 400.

The diagnostic system 400 may track some or all of the selections the user makes on the diagnostic system 400 with respect to a case. Thus, for example, the diagnostic system 400 may record each location and magnification at which a user views an image of a specimen. The diagnostic system 400 may also record other selections, such as those made with respect to the navigation and action bars described above. The user may thus audit his or her analysis of the case by accessing this recorded information to determine, for example, what specimens the he or she has analyzed, and what parts of a single specimen he or she has viewed. Another person, such as a doctor or researcher granted access to this recorded information, may also audit this recorded information for purposes such as education or quality assurance/quality control.

Doctors and researchers analyze specimens in various disciplines. For example, pathologists may analyze tissue and/or blood samples. Hospital and research facilities, for example, may be required to have a quality assurance program. The quality assurance program may be employed by the facility to assess the accuracy of diagnoses made by pathologists of the facility. Additionally, the quality assurance program may gather secondary statistics related to a diagnosis, such as those related to the pathologist throughput and time to complete the analysis, and the quality of equipment used for the diagnosis.

A method of quality assurance in hospitals and research facilities may include having a percentage of case diagnoses made one or more additional times, each time by the same or a different diagnostician. In this method as applied to a pathology example, after a first pathologist has made a diagnosis with respect to a case, a second pathologist may analyze the case and make a second diagnosis. In making the second diagnosis, the second pathologist may obtain background information related to the case, the case including such information as the patient history, gross tissue description, and any slide images that were available to the first pathologist. The background information may also divulge the identity of the first pathologist, along with other doctors and/or researchers consulted in making the original diagnosis.

A reviewer, who may be an additional pathologist or one of the first and second pathologists, compares the first and second diagnoses. The reviewer may analyze any discrepancies between the diagnoses and rate any differences based upon their disparity and significance.

Such a method, however, may introduce bias or other error. For example, the second pathologist, when reviewing the background information related to the case, may be reluctant to disagree with the original diagnosis where it was made by a pathologist who is highly respected. Additionally, there is a potential for bias politically, such as where the original pathologist is a superior to, or is in the same department as, the second pathologist. In an attempt to remove the possibility of such bias, some hospitals and research facilities may direct technicians or secretaries to black out references to the identity of the first pathologist in the case background information. However, such a process is time-consuming and subject to human error.

Additionally, the reviewer in the quality assurance process may obtain information related to both diagnoses, and may thus obtain the identities of both diagnosticians. Knowing the identities may lead to further bias in the review.

Another potential source of bias or other error in the quality assurance process involves the use of glass slides to contain specimens for diagnosis. Where slides are used in the diagnostic process, the first and second pathologists may each view the slides under a microscope. Dependent upon the differences in the first and second diagnoses, the reviewer may also view the slides. Over time and use, the slides and their specimens may be lost, broken, or damaged. Additionally, one of the viewers may mark key areas of the specimen on the slides while analyzing them. Such marking may encourage a subsequent viewer to focus on the marked areas while ignoring others.

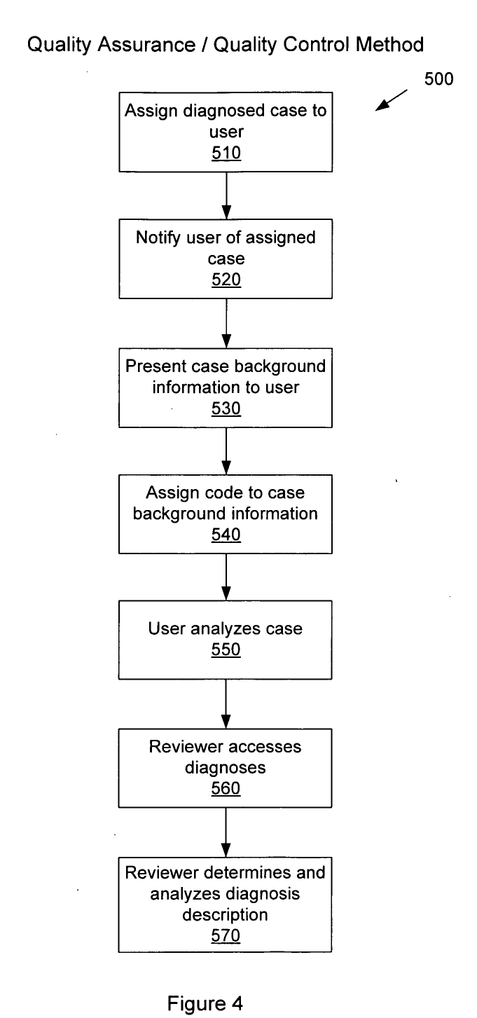

FIG. 4 is a flow chart of one embodiment of a method for providing a quality assurance/quality control (“QA/QC”) system 500 regarding diagnoses of medical samples or other specimens. The QA/QC system 500 may be included in the diagnostic system 400 described above. In this embodiment, the software of the QA/QC system 500 assigns, at 510, a diagnosed case to a user who may be a pathologist, although the case may be assigned to any number and classification of users, such as cytologists, toxicologists, and other diagnosticians. The assignor may be uninvolved in the quality assurance process for the case, in both a diagnostic and reviewing capacity, to ensure the anonymity of the process. The assignment may also be random with respect to the case and the user. The user may receive notification at 520, such as by email or by graphical notation within the imaging interface, that he or she has been assigned the case for diagnosis as part of the QA/QC process. At 530, the user may access the case background information, such as by logging on to the QA/QC system 500 with a user identification and password.

The QA/QC system 500 may make the diagnosis by the user “blind” by making anonymous sources of the case background information. Thus, the QA/QC system 500 may present the case background information at 530 without names such that the user cannot determine the identity of the original diagnostician and any others consulted in making the original diagnosis. Additionally, specimens and other case information may not include a diagnosis or related information or any notations or markings the initial diagnostician included during analysis of the case. However, these notations and markings may still be viewable by the original diagnostician when the original diagnostician logs into the QA/QC system 500 using his or her user identification and password.

The QA/QC system 500 may at 540 assign a random identification number or other code to the case background information so the user will know that any information tagged with that code is applicable to the assigned case.

The case background information may be the same information to which the original diagnostician had access. Thus, for example, where the specimens to be diagnosed are tissue samples disposed on glass slides, the user may access the same captured images of the tissue samples that the original diagnostician analyzed at 530, along with patient history information that was accessible to the original diagnostician.

In one embodiment the case background information available to the user may further include information entered by the original diagnostician, but edited to remove information identifying the original diagnostician.

The user may analyze the case at 550, in the same way as described with respect to 450 of the diagnostic system 400 of FIG. 3 above. In one embodiment, the QA/QC system 500 tracks some or all of the selections each diagnostician user makes on the QA/QC system 500 with respect to a case. Thus, for example, the QA/QC system 500 may record each location and magnification at which a user views an image of a specimen. The system may also record other selections, such as those made with respect to the navigation and action bars described above. The QA/QC system 500 may also record selections made by a reviewer.

After the diagnoses have been made by all users as per the QA/QC process, a reviewer, who may be a doctor or researcher who was not one of the diagnosticians of the case, may access and compare the diagnoses at 560. The reviewer may log in to the QA/QC system such as described above at 530. The reviewer may then, at 570, determine and analyze the discrepancies between the diagnoses and rate any differences based upon their disparity and significance. In one embodiment, the diagnostic information the reviewer receives is anonymous, such that the reviewer can neither determine the identity of any diagnostician nor learn the order in which the diagnoses were made. Providing such anonymity may remove the bias the reviewer may have had from knowing the identity of the diagnosticians or the order in which the diagnoses were made.

Where the reviewer determines that the discrepancy between diagnoses is significant, the reviewer may request that additional diagnoses be made. The QA/QC system 500 may also withhold the identity of the reviewer to provide reviewer anonymity with respect to previous and/or future diagnosticians.

In one embodiment, the QA/QC system 500 may substitute some or all of the function of the reviewer by automatically comparing the diagnoses and preparing a listing, such as in table form, of the discrepancies in some or all portions of the diagnoses. Alternatively, the reviewer may prompt the QA/QC system 500 to conduct such a comparison of diagnostic information that may be objectively compared, without need for the expertise of the reviewer. The reviewer may then review the other diagnostic information as at 570.

In one embodiment, the quality assurance method includes the collection and organization of statistical information in computer databases. The databases may be built by having diagnostic and review information input electronically by each diagnostician and reviewer into the QA/QC system 500. These statistics may include, for example, the number of cases sampled versus the total number processed during a review period; the number of cases diagnosed correctly, the number diagnosed with minor errors (cases where the original diagnoses minimally effect the patient care), and the number of cases misdiagnosed (cases where the original diagnoses have significant defects); the number of pathologists involved; and/or information regarding the number and significance of diagnostic errors with regard to each pathologist. Additional or alternative statistics may include the second pathologist used to make the second diagnosis, the time the reviewer used to review and rate the diagnoses, and/or the number of times the reviewer had to return to the case details before making a decision.

FIG. 5 is a flow chart of one embodiment of a method for providing an educational system 600 for diagnosing medical samples or other specimens. The educational system 600 may provide student users with access at 610 to a system with the basic functionality of the diagnostic system 400 of FIG. 3. By employing the tracking function of diagnostic system 400, a teacher may at 620 audit the selections made by a student user in diagnosing an image of a specimen viewed in the imaging interface of diagnostic system 400. The teacher may view at 620, selection by selection, the selections made by each student. The teacher may then inform the student of proper and imprudent selections the student made.

The educational system 600 may include other information, such as notations with references to portions of specimen images, encyclopedic or tutorial text or image information to which a student user may refer, and/or other information or images that may that may educate a user in diagnosing the specimen.

FIG. 6 illustrates an embodiment of an imaging interface 200 that may be used to display one or more images and information related to images either simultaneously or separately. The imaging interface 200 of that embodiment includes memory 202, a processor 204, a storage device 206, a monitor 208, a keyboard or mouse 210, and a communication adaptor 212. Communication between the processor 204, the storage device 206, the monitor 208, the keyboard or mouse 210, and the communication adaptor 212 is accomplished by way of a communication bus 214. The imaging interface 200 may be used to perform any function described herein as being performed by other than a human and may be used in conjunction with a human user to perform any function described herein as performed by such a human user.

It should be recognized that any or all of the components 202-212 of the imaging interface 200 may be implemented in a single machine. For example, the memory 202 and processor 204 might be combined in a state machine or other hardware based logic machine.

The memory 202 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including an operating system partition 216 in which operating system instructions are stored, a data partition 218 in which data is stored, and an image interface, partition 220 in which instructions for carrying out imaging interface functions are stored. The image interface partition 220 may store program instructions and allow execution by the processor 204 of the program instructions. The data partition 218 may furthermore store data such as images and related text during the execution of the program instructions.

The processor 204 may execute the program instructions and process the data stored in the memory 202. In one embodiment, the instructions are stored in memory 202 in a compressed and/or encrypted format. As used herein the phrase, “executed by a processor” is intended to encompass instructions stored in a compressed and/or encrypted format, as well as instructions that may be compiled or installed by an installer before being executed by the processor 204.

The storage device 206 may, for example, be a magnetic disk (e.g., floppy disk and hard drive), optical disk (e.g., CD-ROM) or any other device or signal that can store digital information. The communication adaptor 212 permits communication between the imaging interface 200 and other devices or nodes coupled to the communication adaptor 212 at the communication adaptor port 224. The communication adaptor 212 may be a network interface that transfers information from nodes on a network to the imaging interface 200 or from the imaging interface 200 to nodes on the network. The network may be a local or wide area network, such as, for example, the Internet, the World Wide Web, or the network 250 illustrated in FIG. 7. It will be recognized that the imaging interface 200 may alternately or in addition be coupled directly to one or more other devices through one or more input/output adaptors (not shown).

The imaging interface 200 is also generally coupled to output devices 208 such as, for example, a monitor 208 or printer (not shown), and various input devices such as, for example, a keyboard or mouse 110. Moreover, other components of the imaging interface 200 may not be necessary for operation of the imaging interface 200. For example, the storage device 206 may not be necessary for operation of the imaging interface 200 as all information referred to by the imaging interface 200 may, for example, be held in memory 202.

The elements 202, 204, 206, 208, 210, and 212 of the imaging interface 200 may communicate by way of one or more communication busses 214. Those busses 214 may include, for example, a system bus, a peripheral component interface bus, and an industry standard architecture bus.

A network in which the imaging interface may be implemented may be a network of nodes such as computers, telephony-based devices or other, typically processor-based, devices interconnected by one or more forms of communication media. The communication media coupling those devices may include, for example, twisted pair, co-axial cable, optical fibers, and wireless communication methods such as use of radio frequencies. A node operating as an imaging interface may receive the data stream 152 from another node coupled to a Local Area Network (LAN), a Wide Area Network (WAN), the Internet, or a telephone network such as a Public Switched Telephone Network (PSTN), or a Private Branch Exchange (PBX).

Network nodes may be equipped with the appropriate hardware, software, or firmware necessary to communicate information in accordance with one or more protocols, wherein a protocol may comprise a set of instructions by which the information is communicated over the communications medium.

FIG. 7 illustrates an embodiment of a network 250 in which the imaging interface may operate. The network may include two or more nodes 254, 256, 258, 260 coupled to a network 252 such as a PSTN, the Internet, a LAN, a WAN, or another network.

The network 250 may include an imaging interface node 254 receiving a data stream such as image related information from a second node such as the nodes 256, 258, and 260 coupled to the network 252.

One embodiment relates to a system and method for digital slide processing, archiving, feature extraction and analysis. One embodiment relates to a system and method for querying and analyzing network distributed digital slides.

Each networked system, according to one embodiment, includes an image system 799, which includes one or more imaging apparatuses 800 and an image server 850, and one or more digital microscopy stations 901, such as shown in and described with respect to FIGS. 9 through 11. In various embodiments, the image system 799 may perform or facilitate performance of some or all parts of each of the methods described with respect to FIGS. 1-5 and 8.

An imaging apparatus 800 may be a device whose operation includes capturing, such as at 110 of FIG. 1, by scanning or otherwise imaging, a digital image of a slide or a non-digital image that is then converted to digital form. An imaging apparatus 800 may include an imager 801 for scanning or otherwise capturing images, one or more image compressors/archivers 803 to compress and store the images, and one or more image indexers 852 to process and extract features from the slide. In an embodiment, features may be described by two values or a vector. The two values may be, for example, texture and roundness that correspond, for example, to nuclear mitotic activity and cancerous dysplasia, respectively.

In one embodiment an imager 801, such as a MedScan™ high speed slide scanner from Trestle Corporation, based in Irvine, Calif., includes a high resolution digital camera 802, microscope optics 807, motion hardware 806, and a controlling logic unit 808. Image transport to a storage device may be bifurcated either at camera level or at system level such that images are sent both to one or more compressors/archivers 803 and to one or more image indexers 852. In an embodiment including bifurcation at the camera level as may be demonstrated with respect to FIG. 9, the output from the camera by way of Ethernet, Firewire USB, wireless, or other communication protocol may be simultaneously transmitted, such as through multicasting, so that both the compressor/archiver 803 and the image indexer 852 receive a copy of the image. In an embodiment including bifurcation at the system level, images may exist in volatile RAM or another high speed temporary storage device, which may be accessed by the compressor/archiver 803 and the image indexer 852.

In one embodiment, the imager 801 includes a JAI CV-M7CL+ camera as the camera 802 and an Olympus BX microscope system as the microscope optics 807 and is equipped with a Prior H101 remotely controllable stage. The Olympus BX microscope system is manufactured and sold by Olympus America Inc., located in Melville, N.Y. The Prior H101 stage is manufactured and sold by Prior Scientific Inc., located in Rockland, Mass.

In one embodiment, the image compressor/archiver 803 performs a primary archiving function and may perform an optional lossy or lossless compression of images before saving the images to storage devices 854. In one embodiment, slide images may be written, such as by compressor/archiver 803, in JPEG in TIFF, JPEG2000, or JPEG2000 in TIFF files using either one or more general purpose CPUs or one or more dedicated compression cards, which the compressor/archiver 803 may include. Original, highest resolution images may be stored together with lower resolution (or sub-band) images constructed from the highest resolution images to form a pyramid of low to high resolution images. The lower resolution images may be constructed using a scale down and compression engine such as described herein, or by another method. To accommodate any file size limitation of a certain image file format (such as the 4 GB limit in a current TIFF specification), the slide image may be stored, in a storage device 854, in multiple smaller storage units or “storage blocks.”

An image compressor/archiver 803 may also provide additional processing and archiving of an image, such as by the generation of an isotropical Gaussian pyramid. Isotropical Gaussian pyramids may be employed for many computer vision functions, such as multi-scale template matching. The slide imaging apparatus 800 may generate multiple levels of the Gaussian pyramid and select all or a subset of the pyramid for archiving. For example, the system may save only the lower resolution portions of the pyramid, and disregard the highest resolution level. Lower resolution levels may be significantly smaller in file size, and may therefore be more practical than the highest resolution level for archiving with lossless compression or no compression. Storage of lower resolution levels, in a storage device 854, in such a high fidelity format may provide for enhanced future indexing capability for new features to be extracted, since more data may be available than with a lossy image. A lossy or other version of the highest resolution image may have been previously stored at the time the image was captured or may be stored with the lower resolution images.

In alternate embodiments of the imaging apparatus 800, the highest resolution images may be kept in storage devices 854 in a primary archive, while the lower resolution versions, such as those from a Gaussian pyramid, may be kept in a storage or memory device of the slide image server 850, in a cache format. The cache may be set to a predetermined maximum size that may be referred to as a “high water mark” and may incorporate utilization statistics as well as other rules to determine the images in the archive for which lower resolution images are to be kept, and/or which components of the lower resolution images to keep. An example of a determination of what images to keep in cache would be the retention of all the lower resolution images for images that are accessed often. An example of a determination of what components of images to keep in cache would be the retention of only the resolution levels for the images that are frequently accessed. The two determinations may be combined, in one embodiment, such that only frequently used resolution levels for frequently accessed files are kept in cache. Other rules, in addition or alternative to rules of access, may be employed and may incorporate some a priori knowledge about the likely utility of the images or components of images to image processing algorithms, as well as the cost of the regeneration of the image data. That is, image data that is highly likely to be used by an image processing algorithm, and/or is highly time intensive to regenerate, may be higher in the priority chain of the cache.

The image indexer 852, which in one embodiment may also be known as the image processor/feature extractor, may perform user definable analytical processes on an image. The processes may include one or more of image enhancement, the determination of image statistics, tissue segmentation, feature extraction, and object classification. Image enhancement may include, for example, recapturing all or portions of an image using new capture parameters such as focal length or lighting level. Image statistics may include, for example, the physical size of the captured image, the amount of memory used to store the image, the parameters used when capturing the image, the focal lengths used for various portions of the captured image, the number of resolutions of the image stored, and areas identified as key to diagnoses. Tissue segmentation may include the size and number of tissue segments associated with a slide or case. Feature extraction may be related to the location and other information associated with a feature of a segment. Object classification may include, for example, diagnostic information related to an identified feature. Computing such properties of image data during the imaging process may afford significant efficiencies. Particularly with respect to steps such as the determination of image statistics, determining the properties in parallel with imaging may be far more efficient than performing the same steps after the imaging is complete. Such efficiency may result from avoiding the need to re-extract image data from media, uncompress the data, format the data, etc. Multiple image statistics may be applied in one or more colorspaces (such as HSV, HIS, YUV, and RGB) of an image. Examples of such statistics include histograms, moments, standard deviations and entropies over specific regions or other similar calculations that are correlated with various physiological disease states. Such image statistics may not necessarily be computationally expensive but may be more I/O bound and therefore far more efficient if performed in parallel with the imaging rather than at a later point, particularly if the image is to be compressed.

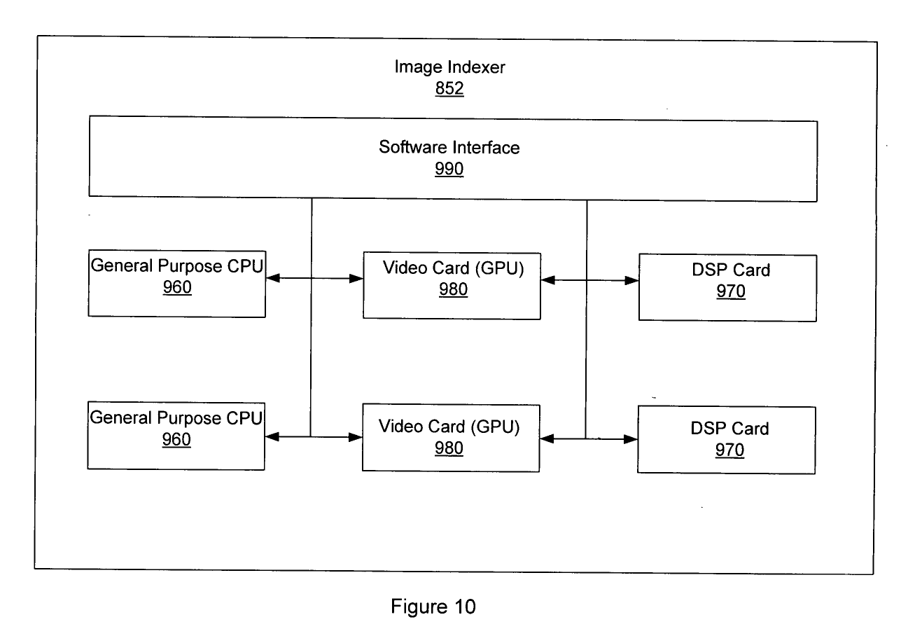

In one embodiment as shown in FIG. 10, an image indexer 852 may include one or more general purpose CPUs 960, digital signal processing boards 970, or graphics processing units (GPUs) 980, which may be included in one or more video cards. Examples of general purpose CPUs 960 include the x86 line from Intel Corporation, and the Power series from IBM Corporation. An example of a digital signal processing board 970 is the TriMedia board from Philips Corporation. It may be estimated that the processing power of GPUs in modern video cards roughly doubles every 6 months, versus 18 months for general purpose CPUs. With the availability of a high level graphics language (such as Cg from Nvidia Corporation, based in Santa Clara, California), the use of GPUs may become more and more attractive. The software interface 990of the image indexer 952may schedule and direct different operations to different hardware for the most efficient processing. For example, for performing morphological operations with an image indexer 852 as in FIG. 9, convolutional filters may be best suited for digital signal processing (DSP) cards 970, certain types of geometrical transformations may be best suited for GPUs 980, while high level statistical operations may be best suited for CPUs 960.

In one embodiment, the image compressor/archiver 803 and the image indexer 852 share the same physical processing element or elements to facilitate speedy communication.

Different types of tissues (e.g., liver, skin, kidney, muscle, brain, eye, etc.) on slides may employ different types of processing for capture of tissue images. Thus, the user may designate a type for each tissue sample on a slide, or the system may automatically retrieve information about the slide in order to determine tissue sample classification information. Classification information may include multiple fields, such as tissue type, preparation method (e.g. formalin fixed, frozen, etc), stain type, antibody used, and/or probe type used. Retrieval of classification information may be accomplished in one of several ways, such as by reading a unique slide identification on the slide, such as RFID or barcode, or as otherwise described herein as desired, or by automatic detection through a heuristic application. In one embodiment, the unique slide identification or other retrieved information does not provide direct classification information, but only a unique identifier, such as a unique identifier (UID), a globally unique identifier (GUID), or an IPv6 address. These identifiers may be electronically signed so as to prevent modification and to verify the authenticity of the creator. This unique identifier may be used to query an external information system, such as a LIS, or LIMS as described herein, to provide the necessary specimen classification information.

The output, or a portion thereof, of the image indexer 852 may be, in one embodiment, in the form of feature vectors. A feature vector may be a set of properties that, in combination, provide some relevant information about the digital slide or portion thereof in a concise way, which may reduce the size of digital slide and associated information down to a unique set of discriminating features. For example, a three-dimensional feature vector may include values or other information related to cell count, texture, and color histogram.

For faster or maximum accuracy and speed, the image indexer may operate on a raw or lossless compressed image. However, certain operations may produce acceptable results with lossy compressed images.

In one embodiment, for certain classifications of liver tissue samples, for example, color saturation may be used by an image indexer 852 to detect glycogenated nuclei in the tissue, since these nuclei are “whiter” than normal nuclei. An adaptive threshold technique using previously saved image statistical information (such as histogram in HSV colorspace) may be used by an image indexer 852 to separate the glycogenated nuclei from normal nuclei. Each nucleus' centroid position, along with other geometric attributes, such as area, perimeter, max width, and max height, and along with color intensities, may be extracted by the image indexer 852 as feature vectors. In another embodiment, some combination of geometric attributes, color intensities, and/or other criteria may be extracted as feature vectors.

The results from the image processor/feature extractor, or image indexer 852, along with slide metadata (such as subject id, age, sex, etc.) and a pointer to the location of the image in the storage device may form a digital slide entity, such as described below, to be stored in a database, such as the image server 850.

The image compressor/archiver 803 may output intermediate results to the image indexer 852 while the multi-resolution image pyramid is being constructed. Feature vectors may then be extracted by the image indexer 852 at every resolution or selected resolutions to benefit future multi-resolution/hierarchical analysis/modeling.

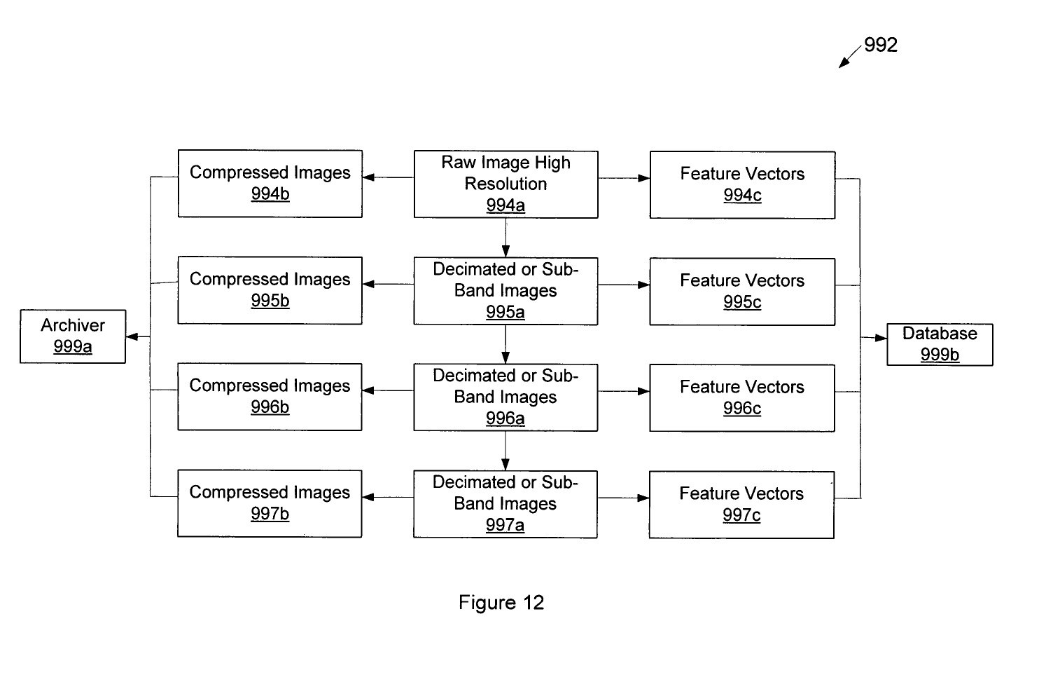

FIG. 12 illustrates a flow chart of an example of an image processing method 992, in accordance with one embodiment. The image processing method 992 may be performed, for example, by an image control system, such as the image system 799 embodiment described with respect to FIG. 9. The imager 801 of the image system 799 may, at 994a, capture a high resolution raw image of a slide and transmit the image to one or more compressors/archivers 803 and to one or more image indexers 852, such as simultaneously or otherwise as described herein, for example. The one or more compressors/archivers 803 may, at 994b, compress the high resolution raw image and, at 999a, archive the image. The one or more image indexers 852 may, at 994c, extract feature vectors from the high resolution raw image and, at 999b, store the feature vectors in a database.

At 995a, image system 799 may process the high resolution raw image and construct a decimated or sub-band image therefrom. The processes of compressing and extracting feature vectors, as in 994b and 999a, and 994c and 999b, may be repeated by the one or more compressors/archivers 803 and by the one or more image indexers 852 at 995b and 999a, and 995c and 999b, respectively, and with respect to the decimated or sub-band image constructed at 995a.

At 996a, the image system may process the decimated or sub-band image from 995a and construct therefrom another decimated or sub-band image. The compression/archiving and extracting and storing feature vector processes may be repeated for the other decimated or sub-band image at 996a at 996b and 999a, and 996c and 999b, respectively.

This process may be repeated at 997a, 997b and 999a, and 997c and 999b.

In an embodiment, the image server 850 may include one or more storage devices 854 for storing slide images, and a relational or object oriented database or other engine 851 for storing locations of slide images, extracted feature vectors from the slide, metadata regarding slides, and system audit trail information

The archived compressed image and feature vectors in the database may be accessible, such as through the image server 850, such as described with respect to FIG. 9.

An image server 850 may be used to store, query and.analyze digital slide entities. A digital slide entity includes, in one embodiment, one or more slide images, feature vectors, related slide metadata and/or data, and audit trail information. Audit trail information may include, for example, recorded information regarding the selections a user makes in employing the system to diagnose a case, such as described herein with respect to the diagnostic system 400 of FIG. 3. The image server 850 may include one or more storage devices 854 for slide images, a relational or object oriented database or other engine 851 for storing locations of slide images, extracted feature vectors from the slide, metadata regarding slides, and system audit trail information. The digital slide server 150 may also be part of a network, such as the network 252 described herein with respect to FIG. 7, and may include one or more smart search agents 860 to perform query and analysis upon request. A smart search agent 860 may retrieve stored images. The image server 850 may also maintain and enforce user privileges, data integrity, and security. To provide security and protect the privacy of the data, different entries in the same digital slide entity may be assigned with different privilege requirements. For example, to satisfy government privacy requirements, patient identification information may not be available (or only be available as a hashed value, or a value associated with a person but not identifying the person to a user) to users outside of the organization. A fee-for-service framework, such as a fee matrix for different types of query/analysis operations, may be included in the image server 850 for accounting purposes.

In one embodiment, certain supervised and/or unsupervised neural network training sessions run in the image server 850. Examples of such neural network functions that may run include automatic quality assurance, which may include functionality of, and/or be employed with, the QA/QC system 500 of FIG. 4, and automatic diagnosis, such as may be employed with respect to the diagnostic system 400 of FIG. 3, using human diagnosis as feedback. An administrator, who may be, for example, an IT professional, may set up and/or modify the networks. Where increased training efficiency is desired, feature vectors may be moved from multiple image servers 850 to a single image server 850 to be accessed during training.

To assist with effective processing, an extensive, hierarchical caching/archiving system may be utilized with, and coupled with, the imaging apparatus 800 and the image server 850. For example, raw images fed from a scanner or other imager 801 may stay in volatile memory for a short time while various processing functions are performed. When the available volatile memory falls below a certain threshold (also known as a “low water mark”), images may be moved to fast temporary storage devices, such as high speed SCSI Redundant Array of Independent Disks (RAID) or FibreChannel Storage Area Network devices. After all initial processing is done, images may be compressed and moved to low cost but slower storage devices (such as regular IDE drives) and may eventually be backed up to a DLT tape library or other storage device. On the other hand, when and if a large amount of volatile memory becomes available (over a certain high water mark), some speculative prediction may be performed to move/decompress certain images to volatile memory/faster storage for future processing.

When multiple image servers 850 are used, data replication may become desirable. Smart replication functionality may be invoked, as there may be much redundancy, for example, in the image data and metadata. Such a smart replication technique may transmit only parts of the image or other data and reconstruct other parts based upon that transmitted data. For example, a low resolution image may be re-constructed from a higher resolution image, such as desired or described herein, such as by software that constructs Gaussian pyramids or other types of multi-resolution pyramids, such as in JPEG in TIFF or JPEG2000 in TIFF. In deciding what data to send, and what not to send but rather to reconstruct, one may weight the processing time, power, or cost to reconstruct an image or portion thereof verses the transmission time or cost to retrieve or transmit the image data from storage. For example, over a high speed local area network (LAN) or high speed Gigabit wide area network (WAN), complete feature vector construction, metadata replication, and image copying (if the security privilege requirement is satisfied) may be a sensible approach from an economic and/or time perspective. On the other hand, over slower Internet or other Wide Area Network (such as a standard 1.5 mbps T1) connections, it may be sensible that only metadata and certain feature vectors are replicated, while images are left on the remote location, such as the image server 850. When query/processing functions are requested in the future, certain operations that need the image data may be automatically delegated to the remote smart search agents 860.

In one embodiment, certain cost metrics may be associated with each type of processing and transmission. For example, the cost metrics may include one coefficient for transmission of 1 MB of image data and another coefficient for decompression and retrieval of 1 MB of image data. A global optimizer may be utilized to minimize the total cost (typically the linear combination of all processing/transmission amounts using the above mentioned coefficients) of the operation. These cost coefficients may be different from fee matrices used for accounting purposes.

In one embodiment of a digital slide server 850, a Network Attached Storage (NAS) from IBM may be used as a storage device 854, an Oracle Relation Database from Oracle may be used as a database engine 851, and several IBM compatible PCs or Blade workstations together with software programs or other elements may serve as smart search agents 860. These devices may be coupled through a high speed local area network (LAN), such as Gigabit Ethernet or FibreChannel, and may share a high speed Internet connection.

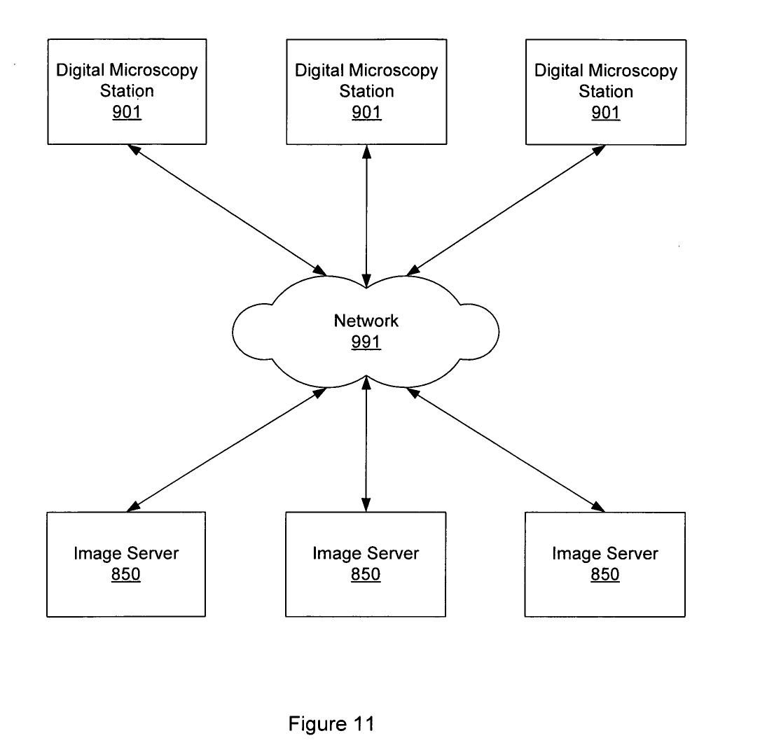

A digital microscopy station 901, such as illustrated in FIG. 11, may, in an embodiment, comprise a workstation or other instrument, such as the image interface 200 described with respect to FIG. 6, or vice versa, and may be to review, analyze, and manage digital slides, and/or provide quality assurance for such operations. A digital microscopy station 901 may include one or more high resolution monitors, processing elements (CPU), and high speed network connections. A digital microscopy station 901 may connect to one or more image servers 850 during operation. It may also communicate with other digital microscopy stations 901 to facilitate peer review, such as the peer review described with respect to the QA/QC system 500 described with respect to FIG. 4.

In an embodiment, the digital microscopy station 901 is used to operate a camera operating to capture an image of a tissue or specimen at a remote location, such as through one or more magnifying lenses and by using a motorized stage. The digital microscopy station 901 may permit its user to input image capture control parameters, such as lens selection, portion of tissue or specimen desired to be viewed, and lighting level. The digital microscopy station 901 may then transmit those parameters to a slide imaging apparatus 800 through a network such as the network 991 illustrated in FIG. 11. The slide imaging apparatus may then capture one or more images in accordance with the control parameters and transmit the captured image across the network to the digital microscopy station.

In one embodiment, a digital microscopy station 901 may receive and transmit a request related to a case and which includes instructions and input from a user, and constructs a set of query/analysis commands, which are then sent to one or more image servers 850. The request may be a request for a slide image and other information related to a case. The commands may include standard SQL, PL/SQL stored procedure and/or Java stored procedure image processing/machine vision primitives that may be invoked in a dynamic language, such as a Java applet.

In one embodiment, a digital microscopy station 901 may include an enhanced MedMicroscopy Station from Trestle Corporation, based in Irvine, California.

An alternative embodiment of a microscopy station 901 is a Web browser-based thin client, which may utilize a Java applet or another dynamic language to communicate capture parameters or receive an image.

Upon receiving the request, the image server 850 may check and verify the credentials and privileges of the user associated with the request. Such credentials and privileges may be accomplished by way of encryption or a password, for example. Where the credentials and privileges are not appropriate for access to requested case information, the image server 850 may reject the request and notify the user of rejection. Where the credentials and privileges are appropriate for access, the image server 850 may delegate the query tasks to the relational or object oriented database engine 851 and image processing/machine vision function to the dedicated smart search agents 860. The results of the query may be returned to the digital microscopy station 901 that provided the request and/or one or more additional digital microscopy stations 901 where requested. The tasks may be performed synchronously or asynchronously. Special privileges may be required to view and/or change the scheduling of concurrent tasks.

In one embodiment, users are divided into technicians, supervisors and administrators. In this embodiment, while a technician may have the privilege to view unprotected images, only a supervisor may alter metadata associated with the images. Unprotected images may be, for example, the images that are reviewed at 152 of FIG. 2 to confirm the images are appropriate for review or amenable to diagnosis. In that embodiment, only an administrator may assign and/or alter the credentials and privileges of another user and audit trail information may not be altered by anyone.

To protect the privacy and integrity of the data stored in the image server 850, a form of secure communication may be utilized between the digital microscopy station 901 and image server 850 and among multiple image servers 850. One embodiment may be based on Secure Socket Layer (SSL) or Virtual Private Network (VPN). User accounts may be protected by password, passphrase, smart card and/or biometric information, for example.

The following are some examples of common tasks that may be performed at a digital microscopy station 901. In one embodiment, a user may employ the digital microscopy station 901 to visually inspect a set of digital slides or images. The user may prompt the digital microscopy station 901 to query or otherwise search for the set, such as by, for example, searching for all images of liver tissues from a particular lab that were imaged in a given time frame. The user may also prompt the digital microscopy station 901 to download or otherwise provide access to the search results. The user may also or alternatively find and access the set by a more complex query/analysis (e.g., all images of tissue slides meeting certain statistical criteria). A user may employ statistical modeling, such as data mining, on a class or set of slide images to filter and thus limit the number of search results. The credentials and privileges of a user may be checked and verified by the image server 850 the user is employing. The user may request a subset of the accessed images to be transmitted to another user for real time or later review, such as collaboration or peer consultation in reaching or critiquing a diagnosis of the user. The user may execute the search before he or she plans to view the search results, such as a day in advance, to allow for download time. The cost of the diagnostic and/or review operations may be calculated according to an established fee matrix for later billing.

In one example of searching, accessing, and filtering functions, a user may employ a digital microscopy station 901 to query an image server 850 to select all images of liver tissues that have a glycogenated nuclei density over a certain percentage, and to retrieve abnormal regions from these tissue images. Other thresholds may be specified in a query such that images of tissues having the borderline criteria may be sent to another user at another digital microscopy workstation 901 for further review.

In one embodiment, the digital microscopy station 901 may be prompted to automatically perform one or more searching, accessing, and filtering functions at a later time based upon certain criteria. For example, the user may prompt the digital microscopy station 901 to automatically and periodically search the image server 850 for all tissue samples meeting a certain criteria and then download any new search results to the digital microscopy station 901.

In one embodiment, one image server 850 at one of the geographic locations of an organization associated with the system, such as a hospital branch, has multiple slide imaging apparatuses 800 or other slide imagers having slides provided regularly for imaging. Technicians at this location may use digital microscopy stations 901 to perform quality assurance and/or quality control, while pathologists or other diagnosticians at another location may use digital microscopy stations 901 to review and analyze the slide images and effectively provide a remote diagnosis. The technicians and diagnosticians may process the images, in one embodiment, through the processes of the image management system 150 of FIG. 2 and the diagnostic system 400 of FIG. 3.

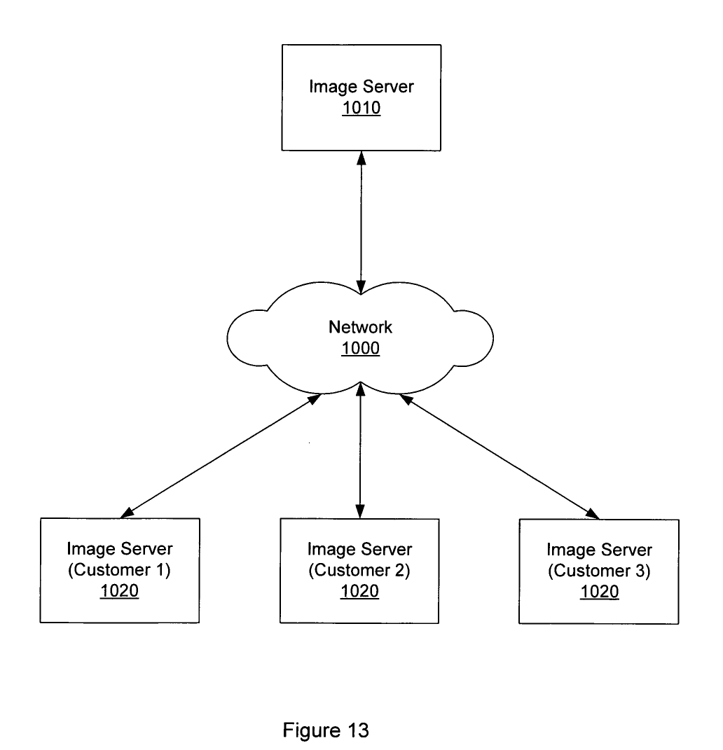

Such a server/client model, employing an image server 850 and digital microscopy stations 901, may include an outsourced imaging laboratory, such as the Trestle ePathNet service and system from Trestle Corporation. In one embodiment of an imaging network 1000, as shown in FIG. 13, a Trestle ePathNet or other server, which may provide pathology data management and virtual microscopy functionality, includes a master image server 1010. The master image server 1010 may include functionality of an image server 850 or portion thereof, while multiple slave image servers 1020 at different customer sites (such as Pharmaceutical companies and Biotechnology laboratories) may each include functionality of an image server 850 or portion thereof. Imagers 801, along with image archivers/compressors 803 and image indexers 852, at customer sites, may each output images as well as feature vectors to the slave image server 1020 to which that imager 801 is coupled.

One or more smart search agents 860 may be located on or in close proximity to the customer's slave image server 1020. Image metadata and predefined feature vectors stored on a slave image server 1020 may be replicated and transmitted to a facility that includes a master image server 1010, such as Trestle's ePathnet server, using a secure communication method, such as SSL or VPN, or another communication method. Query/analysis functions may be commanded, such as via a digital microscopy station 901, to be executed at least partially by smart search agents 860 at the facility. The smart search agents 860 at the facility may then search for and analyze any image metadata and predefined feature vectors stored on the master image server 1010 and/or search for and retrieve data from the slave image server 1020. The smart search agents 860 at the facility may alternatively or additionally delegate tasks to client side, or customer side, smart search agents 860, which may analyze information on a database, which may be on the slave image server 1020, at a customer's facility.

Data transported from a customer site or facility to a master image server 1010, such as at a Trestle facility, may be deidentified data, which may be data in which fields a user has defined as identifying have been removed, encrypted, hashed using a one-way hash function for example such that the identification of the user may not be determined, or translated using a customer controlled codebook. In one embodiment, the deidentified data may be specified automatically by a software program. Using smart replication techniques, offsite database storage and limited image storage may be facilitated. To save bandwidth, primary image storage means, such as a slave image server 1020 having ample storage capacity, may be located at a customer site and may store feature vectors, metadata, and certain lower resolution representations of the slide images that may be replicated at a master image server 1010, such as Trestle Corporation's ePathNet Server, via smart replication. In an embodiment, most or another portion of the high level modeling/data mining may be performed on a powerful master server, such as the ePathNet Server, to limit the amount of analysis on a customer's server, such as a slave image server 1020.

In the digital workplace, various system designs may be employed. For example, streaming images to a view station on an as-needed basis is one process that may be used. Where faster access is desired, the images may be stored locally at the view station computer. But, manual or scripted copying of whole digital slides may be cumbersome, and may not be not network adaptive (e.g., where a system requires a user to download either the whole image file or nothing).

In one embodiment, a system and method is to transport image data for use in creating virtual microscope slides, and may be employed to obtain magnified images of a microscope slide. In this embodiment, the system and method combines of the functionality of both streaming images to and storing images on a computer system in which the images may be viewed. In another embodiment of the system and method, a portion of an image of a slide may be streamed or downloaded to the view station. These embodiments may facilitate more rapid review of a digital slide or slides.

To construct a method employed by a system according to one embodiment, one may begin by examining the anticipated workflow. In the digital workplace, slides may be imaged and stored, such as on the image server 850 described herein or another server, for example, and additional information regarding the slides may also be entered into a database on the server. Next, the data may be reviewed. According to one embodiment, to the extent it is known who is likely to review the data and where that person is located, a system and method may be architected to provide appropriate images and related data to users at appropriate locations more efficiently.

In that embodiment, the system may “push” or “pull” or otherwise transmit or receive all or part of a digital slide, or image of the slide, from an image server, such as the image server 850 described herein, to a review or view station, such as an imaging interface 200 as described herein, in advance of that reviewer actually requesting that particular slide image. Through such early transmission of slide images, the user/reviewer can view the images at high speed. In one embodiment, such a system would retain what might be termed an image server architecture. In an image server architecture, a view station may essentially function like a normal viewer, but may, in an embodiment, also be operating on “auto-pilot.” The view station may automatically, periodically request portions of a slide image (or periodically receive image portions) from the image server and save them locally. As will be understood, a system having this characteristic may retain significant functionality even when all of a particular slide image has not been transferred.

Viewers may, in one embodiment, operate in a framework consistent with browser design and general web server technology, which may be generally referred to as request/response. Viewers may receive (download), from an image server 850 as described herein or another server, a number of pre-streaming rules under which the viewers may operate the system. These rules may include, in various embodiments, rules regarding which slides or slide storage locations the user has access to, what type of writes (e.g. read only, read/write) may be employed, maximum download speed, maximum number of download connections allowed, encryption requirement (e.g., whether data may be required to be downloaded using SSL or similar, or whether the data may be sent unencrypted), whether data may be cached on a local machine unencrypted, and how long downloaded data may be cached. The view stations may then execute viewer requests within these rules, communicating with the image server to view images of a slide as if navigating the actual slide. In other words, the view station may become an analog of its user, but may be operable under the constraints established by the downloaded pre-streaming rules.

The system may be configured to download images from an image server to a view station at a first predetermined viewing resolution, which may be, for example, the second highest resolution available. Lower resolutions of the images may then be generated at the view station from that initially loaded resolution by operation of any of various image processing techniques or algorithms such as described with respect to the imaging apparatus 800 shown in and described with respect to FIG. 9. These lower resolution images may be generated by a flexible, decoupled scale down and compression engine. The scale down and compression engine may operate independently. This independence may allow for flexibility in techniques utilized.

Progressive compression techniques may be employed to integrate separation of an image into resolution components that may then be compressed by utilizing such techniques as quantization and entropy encoding. By decoupling the separation into resolution components from other aspects of compression, flexibility may be afforded. For example, wavelet compression techniques may inherently facilitate the generation of lower resolution images due to the orthogonality of their basis functions. The orthogonality may allow frequencies to be mixed and matched since functions are not codependent. However, the other aspects involved with doing a complete wavelet compression, such as coding, may take substantial amounts of time. Therefore, if only part of the wavelet compression, the initial wavelet decomposition, is utilized in one embodiment, the embodiment can benefit from this aspect of the compression system. After wavelet decomposition, a new image at the desired lower resolution may be reformed. This new image may then be fed into the compression engine. The compression engine may use any lossless or lossy technique, such as JPEG or PNG.

Alternatively, those actual resolutions of the images may be downloaded directly to a view station. If there is sufficient time, images at the highest resolution available may be downloaded first, and lower resolution images may be constructed therefrom, post processed, or latterly downloaded as described above.

If any part of a highest resolution image is not available before actual viewing at a view station, portions of the image at that highest resolution may be downloaded to the view station from a server, such as an image server 850 as described herein, as needed. Image portions may be identified by a user, for example, by their residence at a set of coordinates that define the plane of the slide or image thereof, or their position or location as a slide fraction (e.g., left third, central third, etc . . .).

In one embodiment, the view station automatically downloads higher or highest resolution image portions based on which portions of the low resolution image a user is viewing. The system may automatically download high resolution image portions that are the same, near, and/or otherwise related to the low resolution portions the user is viewing. The system may download these related high resolution images to a cache, to be accessed where a user desires or automatically depending on the further viewing behavior of the user.

For example, in an embodiment, look ahead caching or look ahead buffering may be used and may employ predicative buffering of image portions based upon past user viewing and/or heuristic knowledge. In an embodiment, the look ahead caching or buffering process may be based upon predetermined heuristic knowledge, such as, for example, “a move in one direction will likely result in the next move being in the same direction, a slightly lesser possibility of the next move being in an orthogonal direction, and least likely the move will be in the opposite direction.” In another embodiment, the look ahead caching or buffering may operate based on past usage, such as by analysis of the preponderance of past data to guess next move. For example, if 75% of the user's navigational moves are left/right and 25% up/down, the system may more likely cache image portions to the left or right of the current position before it caches data up or down relative to the current position.

Where some or most review work is routinely performed with relatively low power (low resolution) images, and where some or most of the image file sizes are represented at the highest power, the portions of lower resolution(s) images corresponding to unavailable (not yet downloaded to a view station at time of user viewing) portions of a highest resolution image may be downloaded as a user views the already downloaded images. Because lower resolution image files may be smaller than higher resolution image files, lower resolution files may be downloaded faster, facilitating fast review. Only when and if the user needs to view the (not already downloaded) highest or higher resolution images may there be a more significant latency in retrieval of image data from a remote location.

The image download order, in one embodiment, may be inverted such that the lowest resolution images are downloaded to a view station first, then the next highest, and so on. Such a downloading design may lend itself particularly well to progressive image formats such as progressive jpeg or jpeg2000. In progressive formats, higher resolution images may build on the lower resolution data that has already been sent. Rather than sending an entirely new high resolution image, in one embodiment, only the coefficients that are different between the high resolution and low resolution image may need to be sent. This may result in overall less data being sent, as compared to some other alternative formats, for higher resolution images.

A feature of the system, in one embodiment, is pre-stream downloading, from an image server to a view station during slide imaging. As new portions of the digital slide become available, such as by being imaged and then stored on an image server, they may be transmitted to a view station.

The features of this design may not only complement a digital workflow, but may also, in one embodiment, augment live telepathology. Live telepathology systems may be used for consultations and may, in an embodiment, have certain functional advantages over two dimensional (2d) digital slides for some operations and may be less expensive. Pre-streaming download of the low resolution digital slide(s) of these systems may allow for much more rapid operation of such systems, since the low resolution digital slides may be viewed locally at a view station via such techniques as virtual objective or direct virtual slide review. Thus, a system in this embodiment may include both downloaded images and live telepathology functionality, such that a user may view locally-stored low resolution slide images and, where desired, view live slide images through a telepathology application.

Even with the advent of high speed networks, the methodology and architecture associated with downloading images from an image server, such as the image server 850, to view stations intended for use may facilitate fast operation of the system. By distributing images to view stations, server workload may be reduced. Even with high speed fiber optic lines connecting view stations or other clients to the server, having a number of clients simultaneously hitting the server may negatively affect performance of the system. This affect may be reduced by more efficiently spreading the bandwidth workload of the server.

In one embodiment, a component of the system is an administration interface for a server (referred to herein as the “Slide Agent Server”). The Slide Agent Server may include, for example, an image server 850 and/or a master image server 1010 as described herein, or another system or server. The Slide Agent Server may automatically, or in conjunction with input by a user, such as a case study coordinator or hospital administrator, plan and direct slide traffic. The Slide Agent Server may create a new job, which, as executed, may facilitate the diagnosis and/or review of a case by controlling one or more slide images and other information associated with the case and transporting that information to the view stations of intended diagnosticians and other viewers. The systems and processes for diagnosis and/or review at a view station may be, for example, those systems and processes described herein with respect to FIGS. 3 and 4 and throughout this application.

The job may be described and executed by a script. The script may be written in a standard software programming language such as VBscript, VBA, Javascript, XML, or any similar or suitable software programming language. Each script may be created on an individual basis, for each user or group of users of the system. A script may contain an identifier that is unique (such as a Globally Unique IDentifier (GUID)), an assigned user or users to do the job, a digital signature to verify the authenticity of the job, a text description of the job as well as what slides, cases, or other data are to be reviewed by the user. The creation of the script as well as surrounding administration data, which may include the identity of an intended user, may be editable through a secure web browser interface and may be stored on a central server, such as an image server 850 or other image server. A list of valid users, as well as the authentication information and extent of access to job information of the users, may also be modified.

Each script may then be directed to the software running on an intended user's workstation, designated proxy (a computer that is specified to act on behalf of the user's computer), or other view station. The view station may be, in one embodiment, referred to as a Slide Agent Client. Several security features may be implemented in the Slide Agent Client software program for processing the instructions of each script. For example, the program may require a user to specifically accept each downloaded script before the script is executed. Newly downloaded scripts may also be authenticated by a trusted server through Digital Signature or other methodology. The system may also require authentication of a user to download a script (e.g., before download, the user may be prompted to input his or her username and password). Secure sockets (SSL) may be used for all communications. Files written to cache may be stored in encrypted format.

The Slide Agent Client may display information to the user about the nature of the rules contained in the script to the user, e.g., what type of files, how many files, size of files to be downloaded, etc. The script may also provide a fully qualified identifier for the files to be downloaded (e.g., machine name of server, IP address of server, GUID of server, path, and filename). The script may also specify the data download order. For example, it may specify to load lowest resolutions for all files first, then next lowest resolution for all files, etc. An alternative would be to load all resolutions for a particular file and then proceed to the next specified file. Yet another variation would be to download a middle resolution for each file and then the next higher resolution for each file. Many variations on file sequence, resolutions to be downloaded, and order of resolutions may be specified.

During the download process, queue and file management capabilities may be provided to the user and/or administrator. The Slide Agent Client or Server may display current status of queue specified by the script—files to download, files downloaded, progress, estimated time left for current and total queue, etc. The user of the Slide Agent Client or Server may also be able to delete items from queue, add items from a remote list, and change order in queue of items. The user of the Slide Agent Client or Server may be able to browse basic information about each item in the queue and may be able to view a thumbnail image of each item in the queue. The user of the Slide Agent Client or Server may be able browse and change target directory of each file in the queue. The queue and file management system may also have settings for maximum cache size and warning cache size. A warning cache size may be a threshold of used cache space for which a warning is sent to the user if the threshold is exceeded. The queue and file management system may be able to delete files in cache when cache exceeds limit. This should be selectable based on date of creation, date of download, or last accessed.

Various network features may be present in the system to facilitate efficient downloading. Firstly, firewall tunneling intelligence may be implemented so that the downloads may be executed through firewalls without having to disable or otherwise impair the security provided by the firewall. To accomplish this, one technique may be to make all communication, between the user computer or proxy and the external server, occur through a request/response mechanism. Thus, information may not be pushed to the user computer or proxy without a corresponding request having been sent in advance.

For example, the user computer or proxy may periodically create a request for a new script and send it to the server. When a new script is ready, the server may then send the script as a response. If these requests and response utilize common protocols such as HTTP or HTTPS, further compatibility with firewalls may be afforded.

Another network feature that may be present is presets for each user that specify the maximum download speed at which each user or proxy may download files. These presets may allow traffic on the various networks to be managed with a great deal of efficiency and flexibility. The system may also have bandwidth prioritization features based upon application, e.g., if another user application such as a web browser is employed by the user during the download process, the user application may be given priority and the download speed may be throttled down accordingly. This concept may also be applied to CPU utilization. If a user application using any significant CPU availability is employed, it may be given priority over the downloading application to ensure that the user application runs faster or at the fastest speed possible.

The following table provides an example of a communication that may occur, in an embodiment, between a Slide Agent Client and Slide Agent Server.

| Slide Agent Client | Slide Agent Server | |
|---|---|---|
| Request | Response | Actions |
| GUID and Desc | JobID(s) for GUID | Slide Agent Server: Add |
| | | as new workstation, |
| | | update existing or no |
| | | change |
| | | Slide Agent Client: |
| | | process JobID(s) and |
| | | make individual requests |
| | | for each JobID |
| JobID | Filename list for JobID | Slide Agent Server: |
| | | Create list of filenames for |
| | | JobID with checksum to |
| | | return to agent |
| | | Slide Agent Client: Add |
| | | files for JobID to queue |
| Filename | File | Slide Agent Server: |
| | | Retrieve file from disk and |
| | | return |
| | | Slide Agent Client: Save |
| | | file to cache available for |
| | | MedMicroscopy Viewer |

An example file list may, in one embodiment, look like the following list:

/folder2/Filename1.tif;checksum

/folder2/Filename2.tif;checksum

/folder2/Filename3.tif;checksum

/folder3/Filename2.tif; checksum

Various embodiments of the systems and methods discussed herein may generate on a complete imaged-enhanced patient-facing diagnostic report on a physician or diagnostician desktop.

Various embodiments may ensure consistency and remove bias because all users who analyze the specimen may view the same image, whereas, remote users who utilize glass slides may use different slide sets. Various embodiments may also speed remote diagnosis and cause remote diagnosis to be more cost effective because images may be sent quickly over a network, whereas, with slide review, a separate set of slides may typically be created and mailed to the remote reviewer.

Various embodiments of the systems and methods discussed herein may permit users to view multiple slides simultaneously and speed the image review process. In addition, by utilizing embodiments of the systems discussed herein, slides may avoid damage because they need not be sent to every reviewer.

Various embodiments of the systems and methods discussed herein may be customized with respect to various medical disciplines, such as histology, toxicology, cytology, and anatomical pathology, and may be employed with respect to various specimen types, such as tissue microarrays. With respect to tissue microarrays, various embodiments of the system and methods may be customizable such that individual specimens within a microarray may be presented in grid format by specifying the row and column numbers of the specimens. With regard to toxicology applications, in which many images are quickly reviewed to determine whether disease or other conditions exist, various embodiments of the systems and methods discussed herein may be utilized to display numerous images in a single view to expedite that process.

An embodiment of an article of manufacture that may function when utilizing an image system includes a computer readable medium having 10 stored thereon instructions which, when executed by a processor, cause the processor to depict user interface information. In an embodiment, the computer readable medium may also include instructions that cause the processor to accept commands issued from a user interface and tailor the user interface information displayed in accordance with those accepted commands.

In an embodiment, an image interface includes a processor that executes instructions and thereby causes the processor to associate at least two images of specimens taken from a single organism in a case. The at least two images may be displayed simultaneously or separately.

The execution of the instructions may further cause the processor to display the at least two images to a user when the case is accessed. The execution of the instructions may further cause the processor to formulate a diagnosis from the at least two images in the case. The execution of the instructions may further cause the processor to distinguish areas of interest existing in one or more of the at least two images in the case.

The execution of the instructions may further cause the processor to associate information related to the at least two images with the case. The information may include a first diagnosis. The first diagnosis may be available to a second diagnoser who formulates a second diagnosis, and the executing of the instructions may further cause the processor to associate the second diagnosis with the case. The identity of a first diagnoser who made the first diagnosis may not be available to the second diagnoser. The first and second diagnoses and the identities of the first and second diagnosers who made the first and second diagnoses may be available to a user. The user may determine whether the first and second diagnoses are in agreement. The processor may execute instructions that further cause the processor to determine whether the first and second diagnoses are in agreement. The first diagnosis and the identity of a first diagnoser who made the first diagnosis may not be available to a second diagnoser who formulates a second diagnosis, and the execution of the instructions may further cause the processor to associate the second diagnosis with the case. The identities of the first and second diagnosers who made the first and second diagnoses may not be available to a user.

In an embodiment, a database structure associates at least two images of specimens taken from a single organism in a case.

In an embodiment, a method of organizing a case includes associating at least two images of specimens taken from a single organism in the case, and providing access to the associated at least two images through an image interface.

In an embodiment, an article of manufacture includes a computer readable medium that includes instructions which, when executed by a processor, cause the processor to associate at least two images of specimens taken from a single organism in a case.

In an embodiment, an image verification method includes: resolving whether a first image of a specimen is accepted or rejected for use in diagnosis; forwarding, if the first image is accepted, the first image to a diagnoser; forwarding, if the first image is rejected, the first image to an image refiner, the image refiner altering at least one parameter related to image capture; capturing, if the first image is rejected, a second image of the specimen, with the at least one parameter altered with respect to the capture of the second image; and forwarding, if the second image is captured, the second image to the diagnoser. The diagnoser may be a human diagnostician or a diagnostic device. The image refiner may be a human diagnostician or a diagnostic device. The image verification method may further include resolving whether the second image is accepted or rejected for use in diagnosis.

In an embodiment, an image verification device includes a processor having instructions which, when executed, cause the processor to: resolve whether a first image of a specimen is accepted or rejected for use in diagnosis; forward, if the first image is accepted, the first image to a diagnoser; forward, if the first image is rejected, the first image to an image refiner, the image refiner altering at least one parameter related to image capture; capture, if the first image is rejected, a second image of the specimen, with the at least one parameter altered with respect to the capture of the second image; and forward, if the second image is captured, the second image to the diagnoser.

In an embodiment, an article of manufacture includes a computer readable medium that includes instructions which, when executed by a processor, cause the processor to: resolve whether a first image of a specimen is accepted or rejected for use in diagnosis; forward, if the first image is accepted, the first image to a diagnoser; forward, if the first image is rejected, the first image to an image refiner, the image refiner altering at least one parameter related to image capture; capture, if the first image is rejected, a second image of the specimen, with the at least one parameter altered with respect to the capture of the second image; and forward, if the second image is captured, the second image to the diagnoser.

While the systems, apparatuses, and methods of utilizing a graphic user interface in connection with specimen images have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

What is claimed is:

1. A method for creating an image of a portion of an area, the area having a specimen disposed therein, the process comprising:
determining a probability that the portion is a region of interest;
designating a quality in which to create the image, the designation of the quality based, at least in part, on the probability; and
creating the image at the quality.

2. The method of claim 1, wherein the portion is the region of interest if it at least part of the specimen is disposed on the portion.

3. The method of claim 1, wherein the quality is dependent, at least in part, upon a resolution at which the image is created.

4. The method of claim 1, wherein the quality is dependent, at least in part, upon a speed at which the image is captured.

5. The method of claim 1, wherein the quality is dependent, at least in part, upon an optical resolution of a device capturing the image.

6. The method of claim 1, wherein the quality is dependent, at least in part, upon a focus quality parameter of a device capturing the image.

7. The method of claim 6, wherein the focus parameter is dependent, at least in part, upon a focal distance at which the image is captured.

8. The method of claim 1, wherein the quality is dependent, at least in part, upon a bit-depth capturing ability of a device capturing the image.

9. The method of claim 1, wherein the quality is dependent, at least in part, upon a compression level of the image.

10. The method of claim 1, wherein the quality is dependent, at least in part, upon a compression format of the image.

11. The method of claim 1, wherein the quality is dependent, at least in part, upon an image correction technique to be applied to the image.

12. The method of claim 1, wherein the quality is dependent, at least in part, upon a number of focal planes in which the image is captured.

13. A system for evaluating an area containing a specimen, the system comprising:
an imager to capture an image of a portion of the area; and
a processor to execute instructions to analyze the image and thereby determine a confidence score related to whether at least a part of the specimen is disposed on the portion.

14. The system of claim 13, wherein the confidence score corresponds, at least in part, to a range of probabilities the portion contains the part of the specimen.

15. The system of claim 14, wherein the confidence score corresponds, at least in part, to a probability that the portion contains the part of the specimen.

16. The system of claim 14, wherein the confidence score corresponds, at least in part, to an image quality designation for the portion.

17. The system of claim 16, wherein the correspondence of the confidence score to the image quality designation is based, at least in part, on thresholding.

18. The system of claim 16, wherein the correspondence of the confidence score to the image quality designation is based, at least in part, on adaptive thresholding.

19. A system for evaluating a slide, the system comprising:
an imager to capture an image of the slide; and
a processor to execute instructions to partition the image into portions and to analyze each of the portions to determine an image quality to associate with each of the portions.

20. The system of claim 19, wherein the image quality is selected from at least three values.

21. The system of claim 19, wherein the determination of the image quality for each of the portions is dependent upon the probability each of the portions is a region of interest.

22. The system of claim 19, wherein the image quality is dependent upon one or more imaging parameters.

23. A system for obtaining an image of a portion of an area, the area having a specimen disposed therein, the system comprising:
a processor that executes instructions and thereby causes the processor to determine a probability that the portion is a region of interest and to determine a quality in which to capture the image as a function of the probability; and
an imager to capture the image at the quality.
